(19) United States
(12) Patent Application Publication
(10) Pub. No.: US 2025/0142596 A1
(43) Pub. Date: May 1, 2025

(54) METHOD AND DEVICE FOR PROCESSING COMMUNICATION-DEDICATED RESOURCE IN WIRELESS COMMUNICATION SYSTEM

(71) Applicant: SAMSUNG ELECTRONICS CO., LTD., Suwon-si (KR)

(72) Inventors: Hyunjeong KANG, Suwon-si (KR); Sangyeob JUNG, Suwon-si (KR); Daegyun KIM, Suwon-si (KR)

(21) Appl. No.: 18/927,735

(22) Filed: Oct. 25, 2024

(30) Foreign Application Priority Data
Oct. 26, 2023 (KR) 10-2023-0144635

(51) Int. Cl. H04W 72/25; H04W 4/44

(52) U.S. Cl. CPC H04W 72/25; H04W 4/44

(57) ABSTRACT

The disclosure relates to a 5G or 6G communication system for supporting a higher data transmission rate. A method for processing a control signal in a wireless communication system according to the disclosure includes: receiving a first control signal transmitted from a base station; processing the received first control signal; and transmitting a second control signal generated based on the processing to the base station.

### CROSS-REFERENCE TO RELATED APPLICATION

This application is based on and claims priority under 35 U.S.C. § 119 to Korean Patent Application No. 10-2023-0144635 filed on Oct. 26, 2023, in the Korean Intellectual Property Office, the disclosure of which is incorporated by reference herein in its entirety.

### BACKGROUND

### 1. Field

The disclosure relates to a wireless communication system. Specifically, the disclosure relates to a method and a device, whereby when an uncrewed aerial vehicle (UAV) transmits and receives an aerial to everything (A2X) communication-based service message through a PC5 interface in a wireless communication system, the UAV performs A2X communication through a PC5 interface by using a resource of a UAV-dedicated resource pool.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Terminal-to-terminal direct communication (sidelink communication) using a 5G communication system is being studied, and it is expected that the terminal-to-terminal direct communication is applied to, for example, vehicle-to-everything (hereinafter, referred to as “V2X”), a public safety network, and drone communication and may thus provide various services to a user. For example, the drone communication may be supported by A2X communication, which enables transmission and reception of a service message of an uncrewed mobile aerial vehicle in a terminal-to-terminal direct communication scheme.

The above information is presented as background information only to assist with an understanding of the disclosure. No determination has been made, and no assertion is made, as to whether any of the above might be applicable as prior art with regard to the disclosure.

### SUMMARY

The disclosure provides a method and a device for performing A2X communication through a PC5 interface by using a resource of an uncrewed aerial vehicle (UAV)-dedicated resource pool in a wireless communication system supporting an uncrewed mobile aerial vehicle.

The technical subjects pursued in the disclosure may not be limited to the above-mentioned technical subjects, and other technical subjects which are not mentioned may be clearly understood from the following descriptions by those skilled in the art to which the disclosure pertains.

According to an embodiment of the disclosure for solving the above problem, a method performed by a terminal in a wireless communication system may include: determining whether a UAV-dedicated resource pool is configured; in case of determining that the UAV-dedicated resource pool is configured, further determining whether the configured UAV-dedicated resource pool is usable for terminal identifier broadcast (broadcast remote UE identification (BRID)), whether the configured UAV-dedicated resource pool is usable for collision detection and collision avoidance (detect and avoid (DAA)), or whether the configured UAV-dedicated resource pool is usable for both BRID and DAA; determining whether data that the terminal desires to transmit corresponds to BRID or DAA; determining a logical channel of data to be transmitted according to a logical channel prioritization procedure and determining whether the determined logical channel corresponds to BRID or DAA; in case of determining that the determined logical channel corresponds to BRID, selecting a UAV-dedicated resource pool allowed for BRID transmission and allocating a transmission resource from the corresponding pool; in case of determining that the determined logical channel corresponds to DAA, selecting a UAV-dedicated resource pool allowed for DAA transmission and allocating a transmission resource from the corresponding pool; and transmitting data (BRID or DAA) by using the allocated transmission resource.

According to an embodiment of the disclosure, the method performed by the terminal in the wireless communication system may further include: in case of determining that no UAV-dedicated resource pool is configured, determining whether a general sidelink transmission resource pool configured to transmit UAV service data (BRID or DAA) is configured; and selecting the general sidelink transmission resource pool that is configured to transmit UAV service data, and allocating a transmission resource for transmitting data (BRID or DAA) corresponding to a logical channel determined according to a logical channel prioritization procedure from the selected general sidelink transmission resource pool.

According to an embodiment of the disclosure, secure drone communication or urban air mobility communication can be provided in a wireless communication system.

Advantageous effects obtainable from the disclosure may not be limited to the above-mentioned effects, and other effects which are not mentioned may be clearly understood from the following descriptions by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a scenario for supporting an uncrewed mobile vehicle service message in a wireless communication system according to an embodiment of the present disclosure;

FIG. 2 illustrates a scenario for supporting an uncrewed mobile vehicle service message in a wireless communication system according to an embodiment of the present disclosure;

FIG. 3 illustrates signaling between a terminal and a base station for processing A2X communication transmission resource pool support information in a wireless communication system according to an embodiment of the present disclosure;

FIG. 4 illustrates an operation of a terminal for selecting a UAV transmission resource pool in a wireless communication system according to an embodiment of the present disclosure;

FIG. 5 illustrates an operation of a terminal for selecting a UAV transmission resource pool in a wireless communication system according to an embodiment of the present disclosure;

FIG. 6 illustrates an operation of a terminal for selecting a UAV transmission resource pool in a wireless communication system according to an embodiment of the present disclosure;

FIG. 7 illustrates an operation of a terminal internal layer for processing a UAV transmission resource pool in a wireless communication system according to an embodiment of the present disclosure; and

FIG. 8 illustrates signaling between a terminal and a base station for processing a UAV transmission resource pool in a wireless communication system according to an embodiment of the present disclosure.

FIG. 9 illustrates a structure of a UE according to an embodiment of the present disclosure; and

FIG. 10 illustrates a structure of a base station according to an embodiment of the present disclosure.

### DETAILED DESCRIPTION

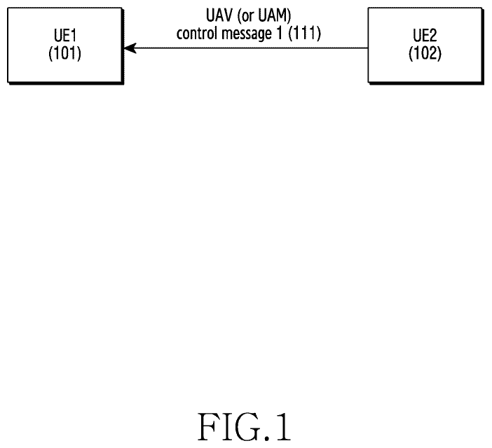

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, exemplary embodiments of the disclosure will be described in detail with reference to the accompanying drawings. It should be noted that, in the accompanying drawings, the same or like elements are designated by the same or like reference signs as much as possible. Also, a detailed description of known functions or configurations that may make the subject matter of the disclosure unnecessarily unclear will be omitted.

In describing the embodiments in the specification, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card.

The following detailed description of embodiments of the disclosure is mainly directed to new radio (NR) as a radio access network and packet core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms referring to signals, terms referring to channels, terms referring to control information, terms referring to network entities, terms referring to device elements, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. However, they are merely examples thereof, and the base station and the terminal are not limited to these examples. In the disclosure, the term “eNB” may be interchangeably used with the term “gNB” for the sake of descriptive convenience. That is, a base station described as “eNB” may refer to “gNB.” In the disclosure, the term “terminal” may refer to not only mobile phones, NB-IoT devices, and sensors, but also various wireless communication devices.

In the following description, the terms “physical channel” and “signal” may be interchangeably used with the term “data” or “control signal.” For example, the term “physical downlink shared channel (PDSCH)” refers to a physical channel over which data is transmitted, but the PDSCH may also be used to refer to the “data.” That is, in the disclosure, the expression “transmit ting a physical channel” may be construed as having the same meaning as the expression “transmitting data or a signal over a physical channel.”

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

Furthermore, as used in the disclosure, the expression “greater than” or “less than” is used to determine whether a specific condition is satisfied or fulfilled, but this is intended only to illustrate an example and does not exclude “greater than or equal to” or “equal to or less than.” A condition indicated by the expression “greater than or equal to” may be replaced with a condition indicated by “greater than,” a condition indicated by the expression “equal to or less than” may be replaced with a condition indicated by “less than,” and a condition indicated by “greater than and equal to or less than” may be replaced with a condition indicated by “greater than and less than.”

In addition, although embodiments of the disclosure are described by using terms used in some communication standards (e.g., 3rd generation partnership project (3GPP)), the terms are merely examples for description. The embodiments of the disclosure may be easily applied to other communication systems through modifications.

A UE-to-UE direct communication (sidelink communication) using a 5G communication system is being studied, and it is expected that the UE-to-UE direct communication is applied to, for example, vehicle-to-everything (hereinafter, referred to as “V2X”), a public safety network, and drone communication and may thus provide various services to a user.

An embodiment of the disclosure is to provide a method and a device, whereby in a wireless communication system supporting an uncrewed mobile aerial vehicle, a terminal selects a transmission resource pool for transmitting a service message corresponding to BRID and allocates a transmission resource, or selects a transmission resource pool for transmitting a service message corresponding to DAA and allocates a transmission resource, based on information for determining a UAV-dedicated resource pool configuration in A2X communication using a PC5 interface for transmitting and receiving a service message of the uncrewed mobile aerial vehicle, and information for determining whether a UAV-dedicated resource pool is for BRID or DAA.

The service message of the uncrewed mobile aerial vehicle may include, for example, at least one or a combination of information corresponding to BRID capable of identifying the uncrewed mobile aerial vehicle and control information corresponding to DAA for controlling the uncrewed mobile aerial vehicle.

According to an embodiment of the disclosure, by synchronizing a wireless transmission profile between UEs which exchange the service message of the uncrewed mobile aerial vehicle in the wireless communication system, secure drone communication and urban air mobility communication may be provided.

The disclosure may provide a method and a device for using a UE-to-UE direct communication interface (e.g., PC5 or a sidelink) in a wireless communication system to control an uncrewed mobile aerial vehicle (e.g., a drone or an uncrewed aerial vehicle (UAV)), or to control a mobile aerial vehicle (e.g., urban air mobility (UAM)) without a pilot or with limited pilot involvement. A scenario of using a UE-to-UE direct communication interface in the disclosure may include a procedure for obtaining UAV identification information or UAM identification information of an uncrewed mobile aerial vehicle or urban air mobility from an agency which regulates the uncrewed mobile aerial vehicle or urban air mobility (e.g., an agency responsible for law enforcement, such as the federal aviation administration). According to regulatory policy, a UE mounted on the uncrewed mobile aerial vehicle may transmit UAV identification information to a UE managed by a regulatory agency.

According to an embodiment, a UE may transmit UAV identification information or UAM identification information through a UE-to-UE direct communication interface. The disclosure may define messages including information necessary for controlling an uncrewed mobile aerial vehicle or urban air mobility as UAV control messages, in addition to a message including the UAV identification information or the UAM identification information. The disclosure is not limited to the example described above, and the UAV control messages may further include various messages.

A UE mounted on an uncrewed mobile aerial vehicle, a UE mounted on urban air mobility, or a UE managed by a regulatory agency (law enforcement) may transmit, receive, and process a UAV control message including required control information through a UE-to-UE direct communication interface. An example of a scenario of using a UAV control message which may be operated according to various embodiments of the disclosure may include UE identifier broadcast control and collision detection and collision avoidance control, as shown in the following [Table 1]. However, the disclosure is not limited thereto.

TABLE 1
Use of A2X (aerial to everything) for BRID (broadcast remote
identification):
the content of the messages for BRID are defined according to the
regional regulations for BRID (e.g., message set of ASTM F3411.19
or ASD-STAN prEN 4709-002 P1) and optionally according to
regional mean of compliance documents.
Use of A2X (aerial to everything) for DAA (detect and avoid):
the content of the messages for DAA are defined according to the
regional regulations for DAA and is out of scope of this specification.

According to various embodiments of the disclosure, the UAV control message may include remote UE identification (used when remotely transmitting a UE identifier of an uncrewed mobile vehicle), a remote UE identification request (used when remotely requesting transmission of a UE identifier of an uncrewed mobile vehicle), remote UE positioning information (used when remotely transmitting location information of an uncrewed mobile vehicle), a remote UE positioning request (used when remotely requesting location information of an uncrewed mobile vehicle), remote UE path information (used when remotely transmitting a driving path of an uncrewed mobile vehicle), a remote UE path request (used when remotely requesting a driving path of an uncrewed mobile vehicle), and detect and avoid (DAA) control (used to notify that a collision of an uncrewed mobile vehicle has been detected or to indicate collision avoidance), and the UAV control message may be transmitted through a PC5 interface.

As an example, an uncrewed mobile vehicle service message including a UE identifier of an uncrewed mobile vehicle, that is, remote UE identification, may be defined as in the following [Table 2]. However, the disclosure is not limited thereto.

TABLE 2
The UE identifier message specification for an uncrewed mobile vehicle
may include the following.
Message set of ASTM F3411.19
ASD-STAN prEN 4709-002 P1
Information included in the UE identifier message specification for the
uncrewed mobile vehicle may include the following.
Standard remote identification: UA ID, UA location/longitude/altitude/
speed, CS location/longitude/altitude, emergency situation and Time Mark
Remote identification broadcast module: module serial number, UA
location/longitude/altitude/speed, takeoff site location/longitude/altitude,
Time Mark
UAS operator registration number, UA unique serial number, Time Mark,
pilot location or takeoff site location, emergency information

An uncrewed mobile vehicle used in the disclosure may include both an uncrewed mobile aerial vehicle and urban air mobility. The disclosure is not limited to the example, and the uncrewed mobile vehicle may include all forms of mobile vehicles without a person on board in addition to an uncrewed mobile aerial vehicle and urban air mobility.

A method performed by a UE in a wireless communication system may include determining whether transmission or reception of a UAV (drone) service message or urban air mobility (UAM) service message using A2X communication based on a PC5 interface is authenticated, determining a transmission (TX) profile mapped to transmit or receive a service message by using the A2X communication based on the PC5 interface, determining a wireless transmission parameter corresponding to the TX profile, performing transmission or reception using the wireless transmission parameter corresponding to the TX profile, and transmitting a destination layer-2 identifier mapped to a service identifier of a service message, PC5 radio access technology (RAT) information mapped thereto, and TX profile information mapped thereto from a higher layer of the UE to an access stratum (AS) layer of the UE.

FIG. 1 illustrates a scenario for supporting an uncrewed mobile vehicle service message in a wireless communication system according to an embodiment of the present disclosure.

Referring to FIG. 1, UE 1 101 and UE 2 102 may be UEs of a wireless communication system supporting an uncrewed mobile vehicle. For example, the UE 1 101 may correspond to a UE managed by an agency which regulates the uncrewed mobile vehicle. The UE 2 102 may correspond to a UE mounted on the uncrewed mobile vehicle. For another example, both the UE 1 101 and the UE 2 102 may correspond to UEs mounted on the uncrewed mobile vehicle. The UE 2 102 may perform broadcast transmission (or groupcast transmission or one-way unicast transmission) of UAV control message1 or UAM control message1 111 to the UE 1 101 through a direct communication interface (e.g., PC5 or a sidelink).

An example of a scenario in which the UE 1 101 and the UE 2 102 transmit and receive uncrewed mobile vehicle control signaling based on FIG. 1 is as follows. The UE 2 102 may transmit its own identification information to the UE 1 101 by using a direct communication interface (e.g., PC5, side link) so that information (authentication information, user registration information, etc.) on an uncrewed mobile vehicle in operation may be identified. The UE 1 101 may be a UE which manages an uncrewed mobile vehicle (e.g., a UE managed by an agency which regulates the uncrewed mobile vehicle). The UE 2 102 may be a UE mounted on the uncrewed mobile vehicle. For example, identification information of the UE 2 102 may be included in UAV control message1 or UAM control message1 110 transmitted by the UE 2 102 to the UE 1 101.

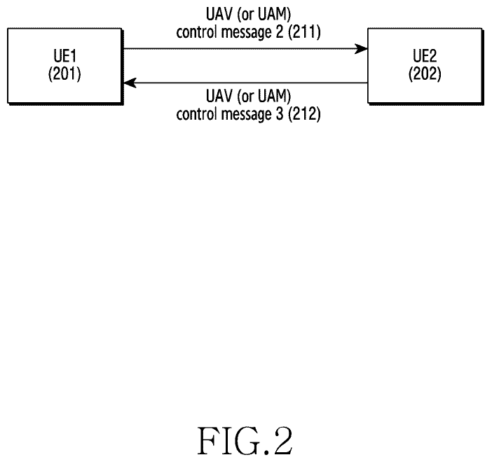

FIG. 2 illustrates a scenario for supporting an uncrewed mobile vehicle service message in a wireless communication system according to an embodiment of the present disclosure.

Referring to FIG. 2, UE 1 201 and UE 2 202 may be UEs of a wireless communication system supporting an uncrewed mobile vehicle. For example, the UE 1 201 may correspond to a UE managed by an agency which regulates the uncrewed mobile vehicle. The UE 2 202 may correspond to a UE mounted on the uncrewed mobile vehicle. For another example, both the UE 1 201 and the UE 2 202 may correspond to UEs mounted on the uncrewed mobile vehicle.

According to an embodiment of the disclosure, the UE 1 201 and the UE 2 202 may perform broadcast transmission (or groupcast transmission or one-way/two-way unicast transmission) of a UAV control message through a direct communication interface (e.g., PC5 or a sidelink).

Referring to FIG. 2, an example of a scenario in which the UE 1 201 and the UE 2 202 transmit and receive uncrewed mobile vehicle control signaling is as follows. In order to enable an agency, which regulates an uncrewed mobile vehicle, to identify information (authentication information, user registration information, etc.) on an uncrewed mobile vehicle in operation, the UE 1 201 managed by the agency which regulates the uncrewed mobile vehicle may transmit UAV (or UAM) control message 2 211 for requesting to transmit identification information to the UE 2 202 mounted on the uncrewed mobile vehicle by using a direct communication interface (e.g., PC5 or a sidelink). The UE 2 202 may transmit UAV (or UAM) control message 3 212 including its own identification information to the UE 1 201 by using a direct communication interface.

In addition, according to an embodiment of the disclosure, at least one or a combination of the UAV control message 2 211 and the UAV control message 3 212 may be transmitted and received between the UE 1 201 and the UE 2 202 to request a flight suspension or to provide information on an allowed flight zone.

According to the embodiments of FIGS. 1 and 2, when both the UE 1 101 or 201 and the UE 2 102 or 202 are UEs mounted on an uncrewed mobile vehicle, a UAV control message transmitted and received by the UE 1 and the UE 2 may correspond to signaling including a movement path and location (e.g., 3D location information) of a UE, or signaling for establishing a direct communication connection and establishing a direct communication connection session to exchange a message including the movement path and location (e.g., 3D location information) of the UE.

When the UE 1 and the UE 2 according to the embodiments of FIGS. 1 and 2 transmit and receive a UAV control message by using A2X communication based on a PC5 interface, the PC5 interface may correspond to a long term evolution (LTE) RAT-based PC5 interface or an NR RAT-based PC5 interface. Therefore, the UE 1 and the UE 2 is required to know information on whether a UAV control message may be transmitted and received using A2X communication based on a PC5 interface, and information on whether a UAV control message may be transmitted and received using an LTE RAT-based PC5 interface or an NR RAT-based PC5 interface when the message may be transmitted and received using A2X communication based on a PC5 interface. Such information may be defined as a TX profile, that is, a wireless transmission profile, which is applicable to the UE 1 and UE 2 to transmit and receive a UAV control message by using A2X communication. In the disclosure, the UAV control message is also referred to as a UAV service message or a UAM service message.

As an embodiment of the disclosure, the policy of the following [Table 3] may be configured for a UE in order for the UE to transmit or receive a UAM service message or a UAV service message based on A2X communication based on a PC5 interface. However, the disclosure is not limited thereto.

TABLE 3
PC5 RAT: indication of whether a PC5 interface of A2X communication
is LTE RAT or NR RAT, or may use both RATs
Cast type: unicast, groupcast, and broadcast indications (for example, a
service message including a UE identifier of an uncrewed mobile vehicle
may be indicated to be transmitted via broadcast)
Frequency: a frequency designated to transmit and receive a UAV service
message or a UAM service message based on A2X communication
RAT selection: LTE PC5 “served (or not served) by E-UTRA” or NR PC5
“served (or not served) by NR” or LTE PC5/NR PC5 “served by E-UTRA
or served by NR” or LTE PC5/NR PC5 “not served by E-UTRA and not
served by NR”
(indicate whether A2X communication based on an LTE PC5 interface can
be serviced in an E-UTRA network, whether A2X communication based
on an NR PC5 interface can be serviced in an NR network, whether A2X
communication based on an LTE PC5 interface can be serviced in an
E-UTRA network or an NR network, whether A2X communication based
on an NR PC5 interface can be serviced in an E-UTRA network or an NR
network, whether A2X communication based on an LTE PC5 interface
can be serviced in both an E-UTRA network and an NR network, whether
A2X communication based on an NR PC5 interface can be serviced in
both an E-UTRA network and an NR network, whether A2X
communication based on an LTE PC5 interface cannot be serviced in both
an E-UTRA network and an NR network, or whether A2X communication
based on an NR PC5 interface cannot be serviced in both an
E-UTRA network and an NR network)
Geographical area, altitude limitation, validity timer: indicate an allowed
location or a restricted location in terms of longitude, latitude, and
altitude as information on an area where a UE is allowed to perform A2X
communication, or indicate valid time information relating to
information on an area indicated as allowed or restricted
A2X service identifier: ITS-AID (ITS application identifier), PSID
(Provider Service Identifier), AID (Application Identifier) according
to the values for aviation applications (identification information of
an A2X service message)
PLMN: information on a PLMN where a UE may perform A2X
communication

When the UE transmits and receives an A2X communication service message to and from another UE through a PC5-based UE-to-UE direct communication scheme, the UE may use a sidelink transmission and reception resource for the A2X communication purpose provided by a serving cell, use a sidelink configuration for the A2X communication purpose provided by the serving cell, use a sidelink transmission resource for the A2X communication purpose allocated by the serving cell, or use a sidelink radio bearer for the A2X communication purpose configured by the serving cell. In this case, the UE needs to determine whether the serving cell supports A2X communication performed through a PC5-based UE-to-UE direct communication scheme, and when the serving cell supports A2X communication performed through a PC5-based UE-to-UE direct communication scheme, needs to determine whether configuration information and transmission resource information required for A2X communication performed through a PC5-based UE-to-UE direct communication scheme are obtained from an SIB message provided by the serving cell.

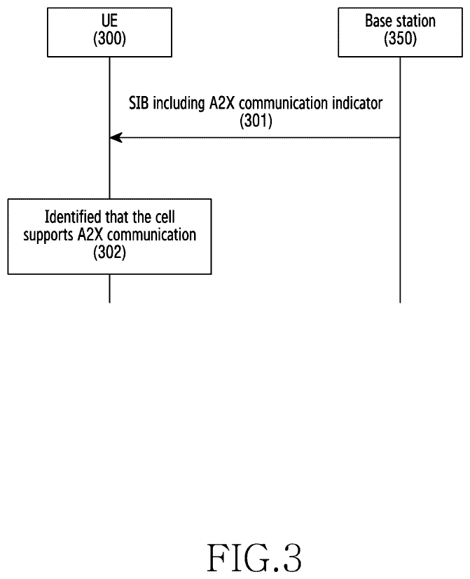

In addition, the UE needs to determine whether a transmission resource allocation mode is a mode in which a base station allocates a transmission resource or a mode in which the UE directly allocates a transmission resource in A2X communication performed through a PC5-based UE-to-UE direct communication scheme. In addition, the UE needs to process a sidelink radio bearer configuration to be used in A2X communication performed through a PC5-based UE-to-UE direct communication scheme. When the serving cell does not support a sidelink configuration or a sidelink transmission resource configuration for the A2X communication purpose, the UE may perform A2X communication through direct communication between another UE and a PC5-based UE by using a sidelink configuration or a sidelink transmission resource configuration that is pre-configured for the A2X communication purpose. The UE may obtain information indicating support for A2X communication from an SIB message transmitted by the base station, as in the embodiment of FIG. 3, to determine whether the base station supports A2X communication performed through a PC5-based UE-to-UE direct communication scheme and whether the base station supports a transmission resource pool required for A2X communication.

Hereinafter, referring to FIGS. 3 to 8, operations of a UE and a base station for processing a transmission resource pool for A2X communication performed through a PC5-based UE-to-UE direct communication scheme will be described. The use of a transmission resource pool for A2X communication may be divided into a case where a transmission resource pool configured for general sidelink-based direct communication, that is, sidelink communication, is shared, and a case where a transmission resource pool is separately configured and used only for A2X communication. A transmission resource pool to be configured for A2X communication may be determined based on a system, a network, and operation rules. If it is determined that a transmission resource pool is configured only for A2X communication, the UE may select the corresponding resource pool to perform data transmission and reception for the A2X communication purpose, and if it is determined that a transmission resource pool only for A2X communication is not configured and that the existing transmission resource pool for the sidelink communication is configured to be shared and used, the UE may select the corresponding resource pool to perform data transmission and reception for the A2X communication purpose.

As an embodiment of configuring a transmission resource pool only for A2X communication, a transmission resource pool separate from the existing transmission resource pool for the sidelink communication may be configured. The transmission resource pool only for A2X communication is not limited to be used for a specific UAV service message type and, instead, may be configured as, for example, a transmission resource pool which may be used for any UAV service message, without distinguishing between a BRID type and a DAA type. If it is determined that the transmission resource pool only for A2X communication is configured, the UE may allocate a transmission resource by selecting the transmission resource pool only for A2X communication, regardless of the type of a UAV service message, that is, for transmitting a message for a BRID type or a message for a DAA type.

If it is determined that there is no configured transmission resource pool only for A2X communication and that the existing transmission resource pool for the sidelink communication purpose is configured to be shared and used with A2X communication, the UE may select a transmission resource pool for the sidelink communication purpose and allocate a transmission resource for, for example, a BRID service message or a DAA service message from the corresponding transmission resource pool. A determination of whether the existing transmission resource pool for the sidelink communication purpose may be shared and used with A2X communication may be based on A2X communication indication information transmitted by the base station (e.g., information indicating support for A2X communication and transmitted in an SIB message) or an operation rule for a transmission resource pool preconfigured for the UE (e.g., configure, for the UE, a transmission resource pool for the sidelink communication purpose which may be shared and used with A2X communication).

Embodiments of a method for configuring a transmission resource pool only for A2X communication may include [Table 4] to [Table 5]. The embodiments of [Table 4] to [Table 5] may include information informing the UE of information indicating that a UAV-dedicated transmission resource pool is configured. When the UAV-dedicated transmission resource pool is configured, the UE may use the configured UAV-dedicated transmission resource pool for A2X communication. Here, the UAV-dedicated transmission resource pool is not limited to a specific UAV service message type and, for example, may be used in A2X communication corresponding to a UAV service message, without distinguishing between a BRID type and a DAA type. The embodiment of [Table 4] includes a configuration of a UAV-dedicated transmission resource pool in a case where A2X communication may be performed based on an NR sidelink communication framework. The embodiment of [Table 5] includes a configuration of a UAV-dedicated transmission resource pool in a case where A2X communication may be performed based on an LTE sidelink communication/LTE V2X communication framework. The embodiment of [Table 5] shows a method for configuring UAV-dedicated transmission resource pool configuration information by using a structure of an SIB21 message as an example, and may also be applied to an RRCReconfiguration message and an SIB26 message transmitted by the base station to the UE in addition to the SIB21 message, and pre-configuration information in which transmission resource pool information is preconfigured for the UE.

```
TABLE 4
    SL-BWP-Config-r16 ::= SEQUENCE {
      sl-BWP-Id BWP-Id,
      sl-BWP-Generic-r16 SL-BWP-Generic-r16 OPTIONAL, -- Need M
      sl-BWP-PoolConfig-r16 SL-BWP-PoolConfig-r16 OPTIONAL, -- Need M
      ...,
      [[
      sl-BWP-PoolConfigPS-r17 SetupRelease {SL-BWP-PoolConfig-r16}
OPTIONAL, -- Need M
      sl-BWP-DiscPoolConfig-r17 SetupRelease {SL-BWP-DiscPoolConfig-r17}
OPTIONAL -- Need M
      ]]
      [[
      sl-BWP-UAVPoolConfig SetupRelease {SL-BWP-UAVPoolConfig} OPTIONAL,
(indicate UAV-dedicated transmission resource pool information)
      ]]
    }
    SL-BWP-UAVPoolConfig ::= SEQUENCE {
      sl-UAVRxPool SEQUENCE (SIZE (1..maxNrofRXPool)) OF SL-ResourcePool,
      sl-UAVTxPoolSelected SEQUENCE (SIZE (1..maxNrofTXPool)) OF SL-
UAVResourcePoolConfig,
      sl-UAVTxPoolExceptional SL-ResourcePoolConfig,
    ...
    }
    SL-UAVResourcePoolConfig ::= SEQUENCE {
      sl-ResourcePoolID SL-ResourcePoolID,
      sl-ResourcePool SL-ResourcePool,
      ...
      }
      SL-ResourcePoolID ::= INTEGER (1..maxNrofPoolID)
```

```
TABLE 5
      SystemInformationBlockType21-r14 ::= SEQUENCE {
        sl-V2X-ConfigCommon-r14 SL-V2X-
ConfigCommon-r14 OPTIONAL, -- Need OR
        lateNonCriticalExtension OCTET STRING
                      OPTIONAL,
        ...,
        [[ anchorCarrierFreqListNR-r16 SL-NR-AnchorCarrierFreqList-
r16   OPTIONAL -- Need OR
        ]]
      [[
      sl-UAV-ConfigComm SL-UAV-ConfigCommon OPTIONAL, (indicate UAV-dedicated
transmission resource pool information)
      ]]
      }
      SL-UAV-ConfigCommon ::= SEQUENCE {
        uav-CommRxPool SL-
CommRxPoolListUAV,
        uav-Comm TxPoolNormalCommon SL-CommTxPoolListUAV,
        uav-Comm TxPoolExceptional SL-CommResourcePoolUAV,
        uav-zoneConfig SL-ZoneConfigUAV,
        thresSL-TxPrioritization     SL-Priority,
          priorityList SL-PriorityList,
      ...
      }
      SL-CommTxPoolListUAV ::= SEQUENCE (SIZE (1..maxSL-UAV-TxPool)) OF
SL-CommResourcePoolUAV
      SL-CommRxPoolListUAV ::= SEQUENCE (SIZE (1..maxSL-UAV-RxPool)) OF
SL-CommResourcePoolUAV
      SL-CommResourcePoolUAV ::= SEQUENCE {
        pool configuration information (detailed information is omitted as it is not relevant to
the disclosure)
        ...
      }
```

As a method for configuring a transmission resource pool only for A2X communication, an A2X communication transmission resource pool may be configured to be used for a specific UAV service message type, for example, configured by distinguishing between a BRID type and a DAA type. In this case, for example, a transmission resource pool may be configured for BRID, a transmission resource pool may be configured for DAA, or a transmission resource pool may be configured for both BRID and DAA. The UE may select a transmission resource pool by determining whether a UAV service message to be transmitted by the UE corresponds to, for example, BRID or DAA. For example, if it is determined that the UAV service message to be transmitted by the UE corresponds to BRID and there is a transmission resource pool configured for BRID or a transmission resource pool configured for both BRID and DAA, the UE may select the corresponding transmission resource pool and allocate a transmission resource for a BRID service message from the corresponding transmission resource pool.

For example, if it is determined that the UAV service message to be transmitted by the UE corresponds to DAA and there is a transmission resource pool configured for DAA or a transmission resource pool configured for both BRID and DAA, the UE may select the corresponding transmission resource pool and allocate a transmission resource for a DAA service message from the corresponding transmission resource pool. For example, when it is determined that the UAV service message to be transmitted by the UE corresponds to BRID, but there is no transmission resource pool configured for BRID or no transmission resource pool configured for both BRID and DAA, or when it is determined that the UAV service message to be transmitted by the UE corresponds to DAA, but there is no transmission resource pool configured for DAA or no transmission resource pool configured for both BRID and DAA, if it is determined that the existing transmission resource pool for the sidelink communication purpose is configured to be shared and used with A2X communication, the UE may select a transmission resource pool for the sidelink communication purpose and allocate a transmission resource for a BRID service message or a DAA service message from the corresponding transmission resource pool.

A determination of whether the existing transmission resource pool for the sidelink communication purpose may be shared and used with A2X communication may be based on A2X communication indication information transmitted by the base station (e.g., information indicating support for A2X communication and transmitted in an SIB message) or an operation rule for a transmission resource pool preconfigured for the UE (e.g., configure, for the UE, a transmission resource pool for the sidelink communication purpose which may be shared and used with A2X communication). As a method for configuring a transmission resource pool only for A2X communication, embodiments of configuration information indicating to the UE that a resource pool is configured for a specific UAV service message type, for example, a transmission resource pool is configured for BRID, a transmission resource pool is configured for DAA, or a transmission resource pool is configured for both BRID and DAA may include [Table 6] to [Table 9]. The embodiments of [Table 6] to [Table 7] include a transmission resource pool configuration by which, in a case where A2X communication may be performed based on an NR sidelink communication framework, a UAV-dedicated transmission resource pool is configured to be used for a specific UAV service message type, for example, to be distinguishably usable for a BRID type and a DAA type.

```
TABLE 6
      SL-BWP-Config-r16 ::= SEQUENCE {
        sl-BWP-Id BWP-Id,
        sl-BWP-Generic-r16 SL-BWP-Generic-r16 OPTIONAL, -- Need M
        sl-BWP-PoolConfig-r16 SL-BWP-PoolConfig-r16 OPTIONAL, -- Need M
        ...,
        [[
        sl-BWP-PoolConfigPS-r17 SetupRelease {SL-BWP-PoolConfig-r16}
OPTIONAL, -- Need M
        sl-BWP-DiscPoolConfig-r17 SetupRelease {SL-BWP-DiscPoolConfig-r17}
OPTIONAL -- Need M
        ]]
        [[
        sl-BWP-UAVPoolConfig SetupRelease {SL-BWP-UAVPoolConfig} OPTIONAL,
(indicate UAV-dedicated transmission resource pool information)
        ]]
      }
      SL-BWP-UAVPoolConfig ::= SEQUENCE {
        sl-UAVRxPool SEQUENCE (SIZE (1..maxNrofRXPool)) OF SL-ResourcePool,
        sl-UAVTxPoolSelected SEQUENCE (SIZE (1..maxNrofTXPool)) OF SL-
UAVResourcePoolConfig,
        sl-UAVTxPoolExceptional SL-ResourcePoolConfig,
      ...
      }
      SL-UAVResourcePoolConfig ::= SEQUENCE {
        sl-ResourcePoolID SL-ResourcePoolID,
        sl-ResourcePool SL-ResourcePool,
        sl-uav-Type ENUMERATED {brid, daa, both}, (indication information indicating
whether this TX resource pool is for BRID, for DAA, or for both BRID and DAA)
        ...
      }
      SL-ResourcePoolID ::= INTEGER (1..maxNrofPoolID)
```

```
TABLE 7
      SL-BWP-Config-r16 ::= SEQUENCE {
        sl-BWP-Id BWP-Id,
        sl-BWP-Generic-r16 SL-BWP-Generic-r16 OPTIONAL, -- Need M
        sl-BWP-PoolConfig-r16 SL-BWP-PoolConfig-r16 OPTIONAL, -- Need M
        ...,
        [[
        sl-BWP-PoolConfigPS-r17 SetupRelease {SL-BWP-PoolConfig-r16}
OPTIONAL, -- Need M
        sl-BWP-DiscPoolConfig-r17 SetupRelease {SL-BWP-DiscPoolConfig-r17}
OPTIONAL -- Need M
        ]]
      [[ (a UAV-dedicated transmission resource pool is indicated, both a pool for BRID and a
pool for DAA may be configured)
        sl-BWP-UAVBRIDPoolConfig SetupRelease {SL-BWP-UAVBRIDPoolConfig}
OPTIONAL, (indication information indicating that this TX resource pool is for BRID)
        sl-BWP-UAVDAAPoolConfig SetupRelease {SL-BWP-UAVDAAPoolConfig}
OPTIONAL, (indication information indicating that this TX resource pool is for DAA)
        sl-BWP-UAVPoolConfig SetupRelease {SL-BWP-UAVPoolConfig} OPTIONAL
(indication information indicating that this TX resource pool may be used for both BRID and
DAA)
        ]]
      }
      SL-BWP-UAVPoolConfig ::= SEQUENCE {
        sl-UAVRxPool SEQUENCE (SIZE (1..maxNrofRXPool)) OF SL-ResourcePool,
        sl-UAVTxPoolSelected SEQUENCE (SIZE (1..maxNrofTXPool)) OF SL-
UAVResourcePoolConfig,
        sl-UAVTxPoolExceptional SL-ResourcePoolConfig,
      ...
      }
      SL-UAVResourcePoolConfig ::= SEQUENCE {
        sl-ResourcePoolID SL-ResourcePoolID,
        sl-ResourcePool SL-ResourcePool,
        ...
      }
      SL-ResourcePoolID::= INTEGER (1..maxNrofPoolID)
```

The embodiments of [Table 8] to [Table 9] include a transmission resource pool configuration by which, in a case where A2X communication may be performed based on an LTE sidelink communication/LTE V2X communication framework, a UAV-dedicated transmission resource pool is configured to be used for a specific UAV service message type, for example, to be distinguishably usable for a BRID type and a DAA type. The embodiments of [Table 8] to [Table 9] show a method for configuring UAV-dedicated transmission resource pool configuration information by using a structure of an SIB21 message as an example, and may also be applied to an RRCReconfiguration message and an SIB26 message transmitted by the base station to the UE in addition to the SIB21 message, and pre-configuration information in which transmission resource pool information is preconfigured for the UE.

```
TABLE 8
      SystemInformationBlockType21-r14 ::= SEQUENCE {
        sl-V2X-ConfigCommon-r14 SL-V2X-ConfigCommon-r14 OPTIONAL, --
Need OR
        lateNonCriticalExtension OCTET STRINGOPTIONAL,
        ...,
        [[ anchorCarrierFreqListNR-r16 SL-NR-AnchorCarrierFreqList-
r16   OPTIONAL -- Need OR
        ]]
      [[
      sl-UAV-ConfigComm SL-UAV-ConfigCommon OPTIONAL, (indication information
indicating a UAV-dedicated transmission resource pool)
      ]]
      }
      SL-UAV-ConfigCommon ::= SEQUENCE {
        uav-CommRxPool SL-
CommRxPoolListUAV,
        uav-CommTxPoolNormalCommon SL-CommTxPoolListUAV,
        uav-CommTxPoolExceptional SL-CommResourcePoolUAV,
        uav-zoneConfig SL-ZoneConfigUAV,
        thresSL-TxPrioritization SL-Priority,
          priorityList SL-PriorityList,
      ...
      }
      SL-CommTxPoolListUAV ::= SEQUENCE (SIZE (1..maxSL-UAV-TxPool)) OF
SL-CommResourcePoolUAV
      SL-CommRxPoolListUAV ::= SEQUENCE (SIZE (1..maxSL-UAV-RxPool)) OF
SL-CommResourcePoolUAV
      SL-CommResourcePoolUAV ::= SEQUENCE {
        pool configuration information (detailed information is omitted as it is not relevant to
the disclosure)
        sl-uav-Type ENUMERATED {brid, daa, both}, (indication information
indicating whether this TX resource pool is for BRID, for DAA, or for both BRID and DAA)
        ...
      }
```

```
TABLE 9
      SystemInformationBlockType21-r14 ::= SEQUENCE {
        sl-V2X-ConfigCommon-r14 SL-V2X-
ConfigCommon-r14 OPTIONAL, -- Need OR
        lateNonCriticalExtension OCTET STRING
                      OPTIONAL,
        ...,
        [[ anchorCarrierFreqListNR-r16 SL-NR-AnchorCarrierFreqList-
r16 OPTIONAL -- Need OR
        ]]
      [[
      sl-UAV-ConfigComm SL-UAV-ConfigCommon OPTIONAL, (indication information
indicating a UAV-dedicated transmission resource pool)
      ]]
      }
      SL-UAV-ConfigCommon ::= SEQUENCE {
        uav-CommRxPool SL-CommRxPoolListUAV,
        uav-CommTxPoolNormalCommonBRID SL-CommTxPoolListUAV, (indication
information indicating that this resource pool is for BRID)
          uav-CommTxPoolNormalCommonDAA SL-CommTxPoolListUAV, (indication
information indicating that this resource pool is for DAA)
          uav-CommTxPoolNormalCommonBRIDandDAA SL-CommTxPoolListUAV,
(indication information indicating that this resource may be used for both BRID/DAA)
        uav-CommTxPoolExceptional SL-CommResourcePoolUAV,
        uav-zoneConfig SL-ZoneConfigUAV,
        thresSL-TxPrioritization SL-Priority,
          priorityList SL-PriorityList,
        ...
        }
        SL-CommTxPoolListUAV ::= SEQUENCE (SIZE (1..maxSL-UAV-TxPool)) OF
SL-CommResourcePoolUAV
        SL-CommRxPoolListUAV ::= SEQUENCE (SIZE (1..maxSL-UAV-RxPool)) OF
SL-CommResourcePoolUAV
        SL-CommResourcePoolUAV ::= SEQUENCE
          pool configuration information (detailed information is omitted as it is not relevant to
the disclosure)
          ...
        }
```

An embodiment of configuration information of the existing sidelink communication transmission resource pool which may be shared and used for A2X communication may include [Table 10] to [Table 11]. In [Table 10] to [Table 11], for convenience of description, only some information is indicated as indication information of the existing sidelink communication transmission resource pool which may be shared for A2X communication, and another transmission resource pool configured for the existing sidelink communication (e.g., a dedicated resource pool configuration and a resource pool configuration applied to power saving) may also be used unless there is a constraint due to the characteristics of A2X communication. The embodiment of [Table 10] includes a method of sharing and using the existing sidelink communication transmission resource pool in a case where A2X communication may be performed based on an NR sidelink communication framework. The embodiment of [Table 11] includes a method of sharing and using the existing sidelink communication transmission resource pool in a case where A2X communication may be performed based on an LTE sidelink communication/LTE V2X communication framework. The embodiment of [Table 11] shows a method for configuring UAV-dedicated transmission resource pool configuration information by using a structure of an SIB21 message as an example, and may also be applied to an RRCReconfiguration message and an SIB26 message transmitted by the base station to the UE in addition to the SIB21 message, and pre-configuration information in which transmission resource pool information is preconfigured for the UE.

```
TABLE 10
      SL-BWP-Config-r16 ::= SEQUENCE {
        sl-BWP-Id BWP-Id,
        sl-BWP-Generic-r16 SL-BWP-Generic-r16  OPTIONAL, -- Need M
        sl-BWP-PoolConfig-r16 SL-BWP-PoolConfig-r16 OPTIONAL, -- Need M (indicate
the existing transmission resource pool for the sidelink communication purpose, which may be
shared and used for A2X communication)
        ...,
        [[
        sl-BWP-PoolConfigPS-r17      SetupRelease {SL-BWP-PoolConfig-r16}
OPTIONAL, -- Need M
        sl-BWP-DiscPoolConfig-r17 SetupRelease {SL-BWP-DiscPool Config-r17}
OPTIONAL -- Need M
        ]]
      }
```

```
TABLE 11
      SystemInformationBlockType21-r14 ::= SEQUENCE {
        sl-V2X-ConfigCommon-r14 SL-V2X-ConfigCommon-r14 OPTIONAL, -- Need
OR (indicate the existing transmission resource pool for the sidelink communication purpose,
which may be shared and used for A2X communication)
        lateNonCriticalExtension OCTET STRINGOPTIONAL,
        ...,
        [[ anchorCarrierFreqListNR-r16 SL-NR-AnchorCarrierFreqList-
r16   OPTIONAL -- Need OR
        ]]
      }
```

Even in a case of sharing the existing transmission resource pool for the sidelink communication purpose for A2X communication, the transmission resource pool may be configured to be used for a specific UAV service message type, for example, configured as a transmission resource pool for a BRID type, configured as a transmission resource pool for a DAA type, or configured as a transmission resource pool for both BRID and DAA. Embodiments of configuration information indicating to the UE that configuration information of the existing sidelink communication transmission resource pool may be used for a specific UAV service message type of A2X communication, for example, for a BRID type and a DAA type may include [Table 12] to [Table 13]. The embodiment of [Table 12] includes a transmission resource pool configuration by which, in a case where A2X communication may be performed based on an NR sidelink communication framework, the existing sidelink communication transmission resource pool is configured to be used for a specific UAV service message type, for example, to be distinguishably usable for a BRID type and a DAA type.

```
TABLE 12
When the existing SL communication resource pool is used for UAV service message
transmission, whether the SL communication resource pool may be configured to be used for a
specific UAV service message type, for example, may be used for a BRID type, for a DAA type,
or for both BRID and DAA may be configured.
An example of configuration information indicating whether the existing SL
communication resource pool may be configured to be used for a specific UAV service message
type, for example, may be used for a BRID type or a DAA type may include the following. The
configuration information may be represented as information indicating a specific UAV service
message type, for example, a BRID type, a DAA type, or BRID/DAA types, the information
being mapped to a pool ID of the existing SL communication resource pool.
      (Embodiment 1)
      SL-ResourcePoolConfig-r16 ::= SEQUENCE {
        sl-ResourcePoolID-r16 SL-ResourcePoolID-r16,
        sl-ResourcePool-r16 SL-ResourcePool-r16,
        sl-uav-Type ENUMERATED {brid, daa, both}, (indication
information indicating whether this TX resource pool is for BRID, for DAA, or for both BRID
and DAA)
      ...
      }
      (Embodiment 2)
      SL-ResourcePoolConfig-r16 ::= SEQUENCE {
        sl-ResourcePoolID-r16 SL-ResourcePoolID-r16,
        sl-ResourcePool-r16 SL-ResourcePool-r16 OPTIONAL -- Need M
      }
      SL-ResourcePoolConfig-uav ::= SEQUENCE {
        sl-ResourcePoolID SL-ResourcePoolID-r16,
        sl-uav-Type ENUMERATED {brid, daa, both}, (indication
information indicating whether this TX resource pool is for BRID, for DAA, or for both BRID
and DAA)
      ...
      }
```

The embodiment of [Table 13] includes a transmission resource pool configuration by which, in a case where A2X communication may be performed based on an LTE sidelink communication/LTE V2X communication framework, the existing sidelink communication transmission resource pool is configured to be used for a specific UAV service message type, for example, to be distinguishably usable for a BRID type and a DAA type.

```
TABLE 13
When the existing SL communication resource pool is used for UAV service message
transmission, whether the SL communication resource pool may be configured to be used for a
specific UAV service message type, for example, may be used for a BRID type, for a DAA type,
or for both BRID and DAA may be configured.
An example of configuration information indicating whether the existing SL
communication resource pool may be configured to be used for a specific UAV service message
type, for example, may be used for a BRID type or a DAA type may include the following. The
configuration information may be represented as information indicating a specific UAV service
message type, for example, a BRID type, a DAA type, or BRID/DAA types, the information
being mapped to a pool ID of the existing SL communication resource pool.
      SystemInformationBlockType21 ::= SEQUENCE {
        sl-V2X-ConfigCommon SL-V2X-ConfigCommon OPTIONAL, -- Need OR
        lateNonCriticalExtension OCTET STRINGOPTIONAL,
        ...,
        [[ anchorCarrierFreqListNR SL-NR-AnchorCarrierFreqList OPTIONAL --
Need OR
        ]]
      }
      SL-V2X-ConfigCommon ::= SEQUENCE {
        v2x-CommRxPool SL-CommRxPoolListV2X OPTIONAL, --
Need OR
        v2x-CommTxPoolNormalCommon SL-CommTxPoolListV2X
        OPTIONAL, -- Need OR
        p2x-CommTxPoolNormalCommon SL-CommTxPoolListV2X
        OPTIONAL, -- Need OR
        v2x-CommTxPoolExceptional SL-CommResourcePoolV2X OPTIONAL, --
Need OR
        zoneConfig SL-ZoneConfig     OPTIONAL, --
Need OR
        uav-zoneConfig SL-ZoneConfigUAV OPTIONAL,     -- Need OR
        thresSL-TxPrioritization SL-Priority OPTIONAL, -- Need OR
          priorityList SL-PriorityList OPTIONAL, -- Need OR
      ...
      }
      SL-CommTxPoolListV2X ::= SEQUENCE (SIZE (1..maxSL-V2X-TxPool)) OF
SL-CommResourcePoolV2X
      SL-CommResourcePoolV2X ::= SEQUENCE {
      pool configuration information (detailed information is omitted as it is not relevant to
the disclosure)
      poolReportId SL-V2X-TxPoolReportIdentity OPTIONAL, -- Need OR
        sl-uav-Type ENUMERATED {brid, daa, both},(indication information
indicating whether this TX resource pool is for BRID, for DAA, or for both BRID and DAA)
      ...
      }
```

FIG. 3 illustrates signaling between a UE and a base station for processing A2X communication transmission resource pool support information in a wireless communication system according to an embodiment of the present disclosure.

Referring to FIG. 3, a UE 300 is authorized to transmit and receive an A2X service message by using A2X communication which employs a UE-to-UE direct communication scheme. The UE 300 may receive an SIB message transmitted by a base station 350 and obtain information indicating whether the base station 350 supports A2X communication. The base station 350 may include a serving cell of the UE. According to the embodiment of FIG. 3, if it is determined that the base station supports A2X communication based on UE-to-UE direct communication, the UE may determine whether configuration information and sidelink transmission/reception resource information capable of performing A2X communication based on UE-to-UE direct communication may be obtained from the base station. Information indicating whether the base station 350 supports A2X communication may be included in an SIB message transmitted by the base station 350. [Table 14] shows an example of the information included in the SIB message and indicating whether the base station 350 supports A2X communication.

TABLE 14
Method 1: A new SIB message (e.g., SIB_A2X) may be used as
information indicating whether a base station supports A2X
communication. The new SIB message is an SIB message defined
for the A2X communication purpose and may include configuration
information, resource allocation information, etc. which may be used
in the A2X communication. When the base station may support the
A2X communication, the base station may transmit the SIB message.
When a UE obtains the SIB message, the UE may determine that the
base station may support the A2X communication.
An SIB_A2X message may have an SIB message format defined in
LTE when A2X communication based on LTE RAT is supported. The
SIB_A2X message may have an SIB message format defined in NR
when A2X communication based on NR RAT is supported.
Method 2: A base station may include, in an SIB message, indication
information indicating whether A2X communication is supported,
and transmit the message. The SIB message may include at least one
or a combination of SIB messages defined for the LTE PC5
communication or NR PC5 communication purpose. The SIB messages
defined for the LTE PC5 communication purpose may include SIB21
and SIB26, and SIB13 and SIB14 corresponding thereto, respectively.
The SIB messages defined for the NR PC5 communication purpose may
include SIB 12. When the base station may support A2X communication
based on LTE RAT, the base station may include, in at least one or a
combination of SIB messages defined for the LTE PC5 communication
purpose, indication information indicating that the A2X communication
is supported, and transmit the same. When the base station may support
A2X communication based on NR RAT, the base station may include, in
at least one or a combination of SIB messages defined for the NR PC5
communication purpose, indication information indicating that the A2X
communication is supported, and transmit the same. When a UE obtains
an SIB message defined for the LTE PC5 communication purpose and
including indication information indicating that A2X communication is
supported, the UE may determine that the base station may support the
A2X communication based on LTE RAT. When the UE obtains an SIB
message defined for the NR PC5 communication purpose and including
indication information indicating that A2X communication is supported,
the UE may determine that the base station may support the A2X
communication based on NR RAT. An example of indication
information indicating that the base station supports A2X communication,
which may be included in an SIB message defined for the LTE PC5
communication purpose and an SIB message defined for the NR PC5
communication purpose, may include the following.
sl-A2X-Communication ENUMERATED {enabled}, OPTIONAL
Method 3: A base station may include, in an SIB message, indication
information indicating whether A2X communication is supported, and
transmit the message. The SIB message may include an SIB1 message.
When the base station may support A2X communication based on LTE
RAT, the base station may include, in an SIB1 message in an LTE format,
indication information indicating that the A2X communication is
supported, and transmit the message. When the base station may support
A2X communication based on NR RAT, the base station may include,
in an SIB1 message in an NR format, indication information indicating
that the A2X communication is supported, and transmit the message.
When a UE obtains the SIB1 message in the LTE format that includes
the indication information indicating that the A2X communication is
supported, the UE may determine that the base station may support the
A2X communication based on LTE RAT. When the UE obtains the
SIBI message in the NR format that includes the indication information
indicating that the A2X communication is supported, the UE may
determine that the base station may support the A2X communication
based on NR RAT. An example of indication information indicating
that the base station supports A2X communication, which may be
included in an SIBI message, may include the following.
sl-A2X-Communication ENUMERATED {enabled}, OPTIONAL

In operation 301, the UE 300 may obtain an SIB message (including the embodiment of [Table 14]) including information indicating whether the base station 350 supports A2X communication. In operation 302, the UE 300 may determine that the base station 350 may support the A2X communication, based on the SIB message received in operation 301. When the UE 300 obtains indication information indicating that the A2X communication is supported from the SIB message transmitted by the base station 350, the UE may use configuration information of a UAV-dedicated transmission resource pool for the A2X communication included in the SIB message, or determine that the existing sidelink communication transmission resource pool included in the SIB message may be shared and used for the A2X communication purpose. The base station 350 capable of supporting the A2X communication may configure a UAV-dedicated transmission resource pool for the A2X communication while configuring indication information indicating that the A2X communication is supported in the SIB message, or may configure the existing sidelink communication transmission resource pool to be shared and used for the A2X communication purpose. When the indication information indicating that the A2X communication is supported is configured in the SIB message transmitted by the base station 350, the configuration information of the UAV-dedicated transmission resource pool for the A2X communication or configuration information of the existing sidelink communication transmission resource pool which may be shared and used for the A2X communication purpose may be included in the SIB message transmitted by the base station 350.

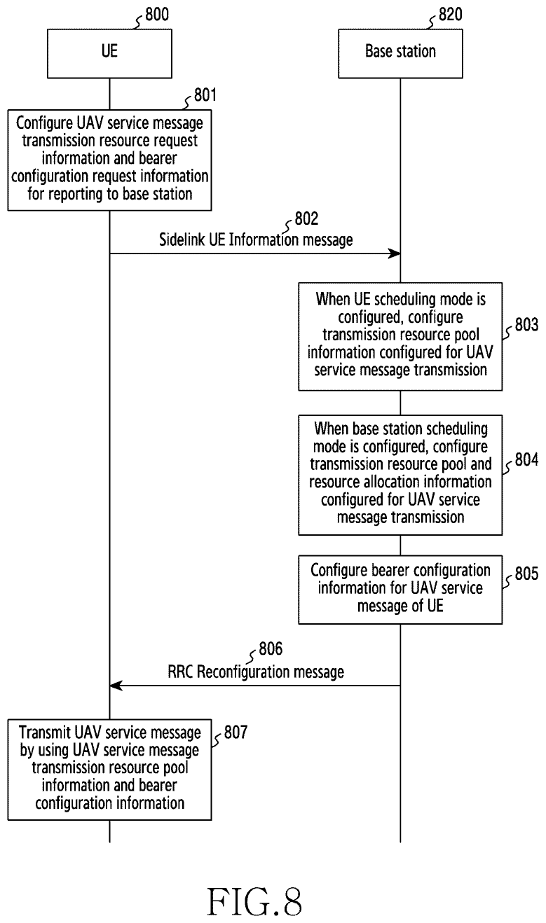

When the indication information indicating that the A2X communication is supported is configured in the SIB message transmitted by the base station 350, the configuration information of the UAV-dedicated transmission resource pool for the A2X communication or the configuration information of the existing sidelink communication transmission resource pool which may be shared and used for the A2X communication purpose may not be included in the SIB message transmitted by the base station 350. In this case, the UE 300 may transmit a sidelink UE information message as in the embodiment of FIG. 8 to request a transmission resource pool for the A2X communication from the base station 350. Examples of configuration information of a UAV-dedicated transmission resource pool for A2X communication which may be configured by the base station 350 supporting the A2X communication and may be obtained by the UE 300 which desires to perform the A2X communication, and configuration information of the existing sidelink communication transmission resource pool which may be shared and used for the A2X communication purpose may include the embodiments of [Table 4] to [Table 13].

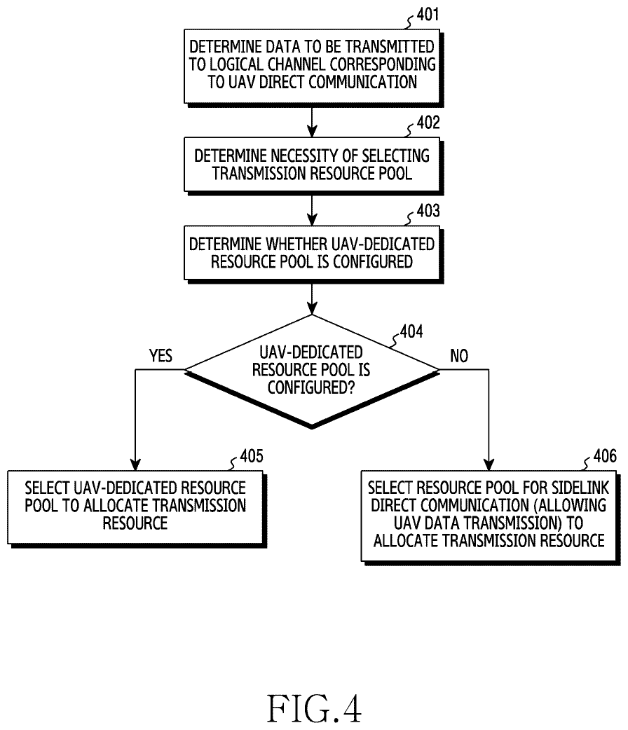

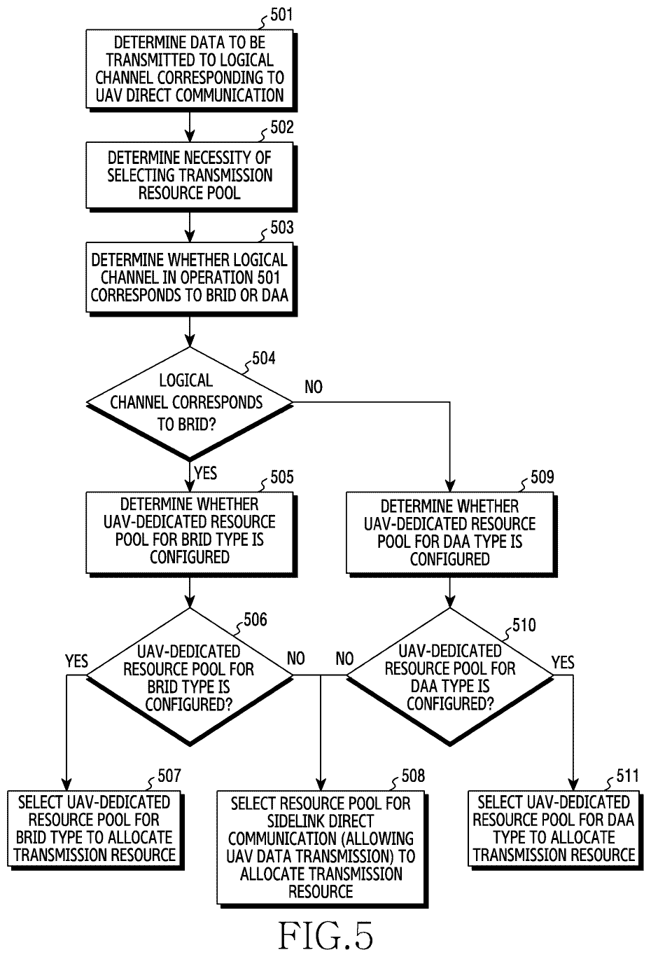

An embodiment of an operation in which a UE selects a transmission resource pool and allocates a transmission resource to transmit a UAV service message, based on configuration information of a UAV-dedicated transmission resource pool for the A2X communication purpose or configuration information of the existing sidelink communication transmission resource pool which may be shared and used for the A2X communication purpose, as in the embodiments of [Table 4] to [Table 13], will be described with reference to FIGS. 4, 5, and 6. FIG. 4 illustrates an embodiment in which a UE which desires to transmit a UAV service message selects a transmission resource pool and allocates a transmission resource in a case where a UAV-dedicated transmission resource pool and the existing sidelink communication transmission resource pool are configured. FIG. 5 illustrates an embodiment in which a UE which desires to transmit a UAV service message selects a transmission resource pool and allocates a transmission resource in a case where a UAV-dedicated transmission resource pool may be configured to be used for specific UAV service message types, for example, configured separately for a BRID type and a DAA type, and a case where the existing sidelink communication transmission resource pool is configured.

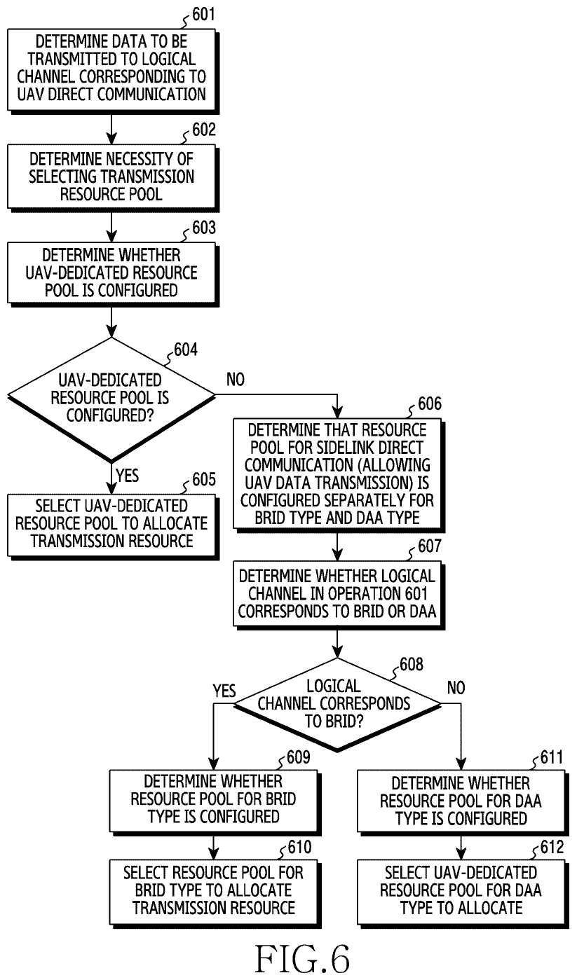

FIG. 6 illustrates an embodiment in which a UE which desires to transmit a UAV service message selects a transmission resource pool and allocates a transmission resource in a case where a UAV-dedicated transmission resource pool (the embodiment of FIG. 6 is based on an assumption of both a case where a UAV-dedicated transmission resource pool is not configured to be used for specific UAV service message types, for example, not configured separately for a BRID type and a DAA type, and a case where a UAV-dedicated transmission resource pool is configured to be used for specific UAV service message types, for example, configured separately for a BRID type and a DAA type) and the existing sidelink communication transmission resource pool are configured (the embodiment of FIG. 6 is based on an assumption of a case where the existing sidelink communication transmission resource pool may be configured to be used for specific UAV service message types, for example, configured separately for a BRID type and a DAA type).

According to an embodiment of the disclosure, when there is a UAV service message, for example, data to be transmitted for a logical channel corresponding to BRID or DAA, the UE may determine whether there is a transmission resource pool configured to transmit the UAV service message. When a separate transmission resource pool is configured to transmit a UAV service message, the UE may select the separate transmission resource pool configured to transmit the UAV service message. When a separate transmission resource pool is not configured to transmit a UAV service message, the UE may select the existing sidelink communication transmission resource pool (a transmission resource pool which is allowed to transmit a UAV service message). The UE may allocate a transmission resource from the selected transmission resource pool. The operation of allocating the transmission resource by the UE may be based on sensing, for example, a mode 2 operation of an NR sidelink communication framework or a mode 4 operation of an LTE V2X communication framework. When a separate transmission resource pool is configured to transmit a UAV service message, or when the existing sidelink communication transmission resource pool is configured to transmit a UAV service message, the transmission resource pool may be distinguishably configured for specific UAV service message types, for example, a BRID type and a DAA type.

The UE may select a transmission resource pool configured for BRID when a UAV service message to be transmitted corresponds to a specific UAV service message type, for example, BRID, and there is data to be transmitted for a logical channel corresponding to BRID. The UE may select a transmission resource pool configured for DAA when a UAV service message to be transmitted corresponds to a specific UAV service message type, for example, DAA, and there is data to be transmitted for a logical channel corresponding to DAA. When a transmission resource pool is configured to be used for specific UAV service message types, for example, configured for both a BRID type and a DAA type, the transmission resource pool may be selected in both a case where there is data to be transmitted for a logical channel corresponding to BRID and a case where there is data to be transmitted for a logical channel corresponding to DAA. When a UAV service message to be transmitted by the UE corresponds to BRID and there is data to be transmitted for a logical channel corresponding to BRID, if it is determined that there is no transmission resource pool configured for BRID, the UE may select the existing sidelink communication transmission resource pool (a transmission resource pool which is allowed to transmit a UAV service message) and allocate a transmission resource. When a UAV service message to be transmitted by the UE corresponds to DAA and there is data to be transmitted for a logical channel corresponding to DAA, if it is determined that there is no transmission resource pool configured for DAA, the UE may select the existing sidelink communication transmission resource pool (a transmission resource pool which is allowed to transmit a UAV service message) and allocate a transmission resource. When an HARQ feedback is configured for a logical channel corresponding to a UAV service message, the UE may select a transmission resource pool in which an HARQ feedback channel (e.g., a PSFCH channel) is configured, and allocate a transmission resource.

When a transmission resource pool for transmitting an SL CSI reporting MAC CE is required to be selected for a unicast connection corresponding to a UAV service message, the UE may select a transmission resource pool configured to transmit the UAV service message, and allocate a transmission resource. When the transmission resource pool configured to transmit the UAV service message is configured to be used for specific UAV service message types, for example, distinguishably configured for a BRID type and a DAA type, the UE may select a transmission resource pool corresponding to a specific UAV service message type (e.g., BRID or DAA) corresponding to a unicast connection corresponding to an SL CSI reporting MAC CE and allocate a transmission resource. Embodiments of an operation of selecting a UAV service message transmission resource pool and allocating a transmission resource by the UE will be described with reference to FIGS. 4, 5, and 6.

FIG. 4 illustrates an operation of a UE for selecting a UAV transmission resource pool in a wireless communication system according to an embodiment of the present disclosure.

Referring to FIG. 4, in operation 401, when a UE performs A2X communication by using a PC5 direct communication scheme, the UE may determine whether there is data to be transmitted on a logical channel corresponding to a UAV service message. It is assumed that mapping between a PC5 QoS flow corresponding to a UAV service message to be transmitted by the UE and a sidelink radio bearer and a sidelink logical channel is configured through an NR sidelink communication framework, or mapping between a sidelink radio bearer and a sidelink logical channel is configured for a packet corresponding to a UAV service message to be transmitted by the UE through an LTE sidelink communication/LTE V2X communication-based framework.

In operation 402, if it is determined based on the determination in operation 401 that there is the data to be transmitted for the corresponding logical channel, the UE may determine whether it is necessary to select a transmission resource pool for the data to be transmitted for the corresponding logical channel. If the UE determines that there is a transmission resource pool already selected for the corresponding logical channel when there is the data to be transmitted for the corresponding logical channel based on the determination of the UE in operation 402, the UE may allocate a transmission resource from the selected transmission resource pool and transmit the data in operation 401 by using the allocated transmission resource.

In operation 403, if it is determined based on the determination in operation 402 that the UE is required to select a transmission resource pool for the corresponding logical channel when there is the data to be transmitted for the corresponding logical channel, the UE may determine whether there is a transmission resource pool configured separately for UAV service message transmission.

In operation 404, if it is determined that there is the transmission resource pool configured separately for UAV service message transmission, the UE may proceed to operation 405 to select the transmission resource pool configured separately for UAV service message transmission and allocate a transmission resource from the selected transmission resource pool.

In operation 405, the operation of allocating the transmission resource from the selected transmission resource pool by the UE may include an operation of selecting a transmission resource by the UE based on sensing in mode 2 of an NR sidelink communication framework or an operation of selecting a transmission resource by the UE based on sensing in mode 4 of an LTE V2X communication framework.

If it is determined in operation 404 that there is no transmission resource pool configured separately for UAV service message transmission, the UE may proceed to operation 406 to determine whether the existing sidelink communication transmission resource pool is configured to be used for UAV service message transmission. In addition, if it is determined the existing sidelink communication transmission resource pool is configured to be used for UAV service message transmission, the UE may select the existing sidelink communication transmission resource pool and allocate a transmission resource from the selected transmission resource pool.

The operation of allocating the transmission resource from the selected transmission resource pool by the UE in operation 406 may include an operation of selecting a transmission resource by the UE based on sensing in mode 2 of an NR sidelink communication framework or an operation of selecting a transmission resource by the UE based on sensing in mode 4 of an LTE V2X communication framework. An embodiment of the operation of determining whether the existing sidelink communication transmission resource pool is configured to be used for UAV service message transmission by the UE in operation 406 may include the embodiment of FIG. 3.

In the embodiment of FIG. 4, an HARQ feedback may be configured for a logical channel corresponding to a UAV service message. That is, in a case where the UAV service message is transmitted and received through a sidelink unicast connection or a sidelink groupcast connection, an HARQ feedback may be configured for a logical channel for a certain UAV service message and an HARQ feedback may not be configured for a logical channel for a certain UAV service message. When the HARQ feedback is configured for the logical channel corresponding to the UAV service message, the UE may select a transmission resource pool in which an HARQ feedback channel (e.g., a PSFCH channel) is configured. For example, if data to be transmitted by the UE corresponds to a DAA service message, a sidelink unicast connection is established for the DAA service message, and an HARQ feedback is configured for a logical channel corresponding to the DAA service message, in operation 405 or 406, the UE may select a transmission resource pool in which an HARQ feedback resource is configured, and allocate a transmission resource from the selected transmission resource pool.

FIG. 5 illustrates an operation of a UE for selecting a UAV transmission resource pool in a wireless communication system according to an embodiment of the present disclosure.

Referring to FIG. 5, in operation 501, when a UE performs A2X communication by using a PC5 direct communication scheme, the UE may determine whether there is data to be transmitted on a logical channel corresponding to a UAV service message. It is assumed that mapping between a PC5 QoS flow corresponding to a UAV service message to be transmitted by the UE and a sidelink radio bearer and a sidelink logical channel is configured through an NR sidelink communication framework, or mapping between a sidelink radio bearer and a sidelink logical channel is configured for a packet corresponding to a UAV service message to be transmitted by the UE through an LTE sidelink communication/LTE V2X communication framework.

In operation 502, if it is determined based on the determination in operation 501 that there is the data to be transmitted for the corresponding logical channel, the UE may determine whether it is necessary to select a transmission resource pool for the data to be transmitted for the corresponding logical channel. If the UE determines that there is a transmission resource pool already selected for the corresponding logical channel when there is the data to be transmitted for the corresponding logical channel based on the determination in operation 502, the UE may allocate a transmission resource from the selected transmission resource pool and transmit the data in operation 501 by using the allocated transmission resource.

In operation 503, if it is determined based on the determination in operation 502 that a transmission resource pool is required to be selected for the corresponding logical channel when there is the data to be transmitted for the corresponding logical channel, the UE may determine whether there is a transmission resource pool configured separately for UAV service message transmission.

The embodiment of FIG. 5 is based on an assumption that for UAV service message transmission, a separate transmission resource pool may be configured to be used for specific UAV service message types, for example, distinguishably configured for a BRID type and a DAA type. That is, a transmission resource pool separately configured for UAV service message transmission may be configured to transmit only a BRID type message, may be configured to transmit only a DAA type message, or may be configured to be used for both the BRID type and the DAA type.

In operation 504, the UE may determine whether the logical channel in operation 501 corresponds to a specific UAV service message type, for example, BRID.

In operation 505, if the logical channel corresponds to BRID based on the determination in operation 504, the UE may determine whether a transmission resource pool for UAV service message transmission is configured for a BRID type. The UAV service message transmission resource pool configured for the BRID type may include a transmission resource pool configured to transmit only a BRID type message, or a transmission resource pool configured to be used in both BRID and DAA types.

In operation 506, if the UE determines that the transmission resource pool for UAV service message transmission is configured for the BRID type, in operation 507, the UE may select the transmission resource pool for UAV service message transmission configured for the BRID type and allocate a transmission resource from the selected pool.

If it is determined based on the determination in operation 506 that the transmission resource pool for UAV service message transmission is not configured for the BRID type, in operation 508, the UE may determine whether the existing sidelink communication transmission resource pool allowed for UAV service message transmission is configured, select the corresponding sidelink communication transmission resource pool, and allocate a transmission resource.

An embodiment of the operation of determining whether the existing sidelink communication transmission resource pool is configured to be used for UAV service message transmission by the UE in operation 508 may include the embodiment of FIG. 3.

If it is determined based on the determination in operation 504 that the logical channel of the data to be transmitted does not correspond to BRID, the UE may determine that the logical channel in operation 501 corresponds to another specific UAV service message type, for example, DAA. In the embodiment of FIG. 5, it is described under an assumption that a UAV service message corresponds to BRID or corresponds to DAA, but other UAV service message types which do not correspond to BRID and DAA are not excluded. Even for other UAV service message types which do not correspond to BRID and DAA, the UE may operate similarly to the embodiment of FIG. 5 according to the operation of a UAV service message transmission resource.

In operation 509, the UE may determine whether a transmission resource pool for UAV service message transmission is configured for a DAA type. The UAV service message transmission resource pool configured for the DAA type may include a transmission resource pool configured to transmit only a DAA type message or a transmission resource pool configured to be used in both BRID and DAA types.

In operation 510, if the UE determines that the transmission resource pool for UAV service message transmission is configured for the DAA type, in operation 511, the UE may select the transmission resource pool for UAV service message transmission configured for the DAA type and allocate a transmission resource from the selected pool. If it is determined based on the determination in operation 510 that the transmission resource pool for UAV service message transmission is not configured for the DAA type, in operation 508, the UE may determine whether the existing sidelink communication transmission resource pool allowed for UAV service message transmission is configured. In addition, the UE may select the corresponding sidelink communication transmission resource pool and allocate a transmission resource. An embodiment of the operation of determining whether the existing sidelink communication transmission resource pool is configured to be used for UAV service message transmission by the UE in operation 508 may include the embodiment of FIG. 3.

The operation of allocating the transmission resource from the selected transmission resource pool by the UE in operation 507, 508, or 511 may include an operation of selecting a transmission resource by the UE based on sensing in mode 2 of an NR sidelink communication framework or an operation of selecting a transmission resource by the UE based on sensing in mode 4 of an LTE V2X communication framework. When the UE performs the operation of determining whether the existing sidelink communication transmission resource pool allowed for UAV service message transmission is configured in operation 508, the UE may handle a case where the sidelink communication transmission resource pool is configured to be used for a specific UAV service message type, for example, distinguishably configured for a BRID type and a DAA type, a UE operation therefor will be described with reference to FIG. 6.

In the embodiment of FIG. 5, an HARQ feedback may be configured for a logical channel corresponding to a UAV service message. That is, in a case where the UAV service message is transmitted and received through a sidelink unicast connection or a sidelink groupcast connection, an HARQ feedback may be configured for a logical channel for a certain UAV service message and an HARQ feedback may not be configured for a logical channel for a certain UAV service message. If the HARQ feedback is configured for the logical channel corresponding to the UAV service message, the UE may select a transmission resource pool in which an HARQ feedback channel (e.g., a PSFCH channel) is configured. It may be assumed that an HARQ feedback is configured for a logical channel corresponding to a DAA service message among UAV service message types. For example, if data to be transmitted by the UE corresponds to the DAA service message, a sidelink unicast connection is established for the DAA service message, and the HARQ feedback is configured for the logical channel corresponding to the DAA service message, in operation 511 or 508, the UE may select a transmission resource pool in which an HARQ feedback resource is configured, and allocate a transmission resource from the selected transmission resource pool.

The embodiment of FIG. 6 may include an operation of selecting a transmission resource pool by the UE in a case where when the existing sidelink communication transmission resource pool is shared and used for UAV service message transmission, the sidelink communication transmission resource pool is configured to be used for specific UAV service message types, for example, distinguishably configured for a BRID type and a DAA type. The embodiment of FIG. 6 is based on an assumption that at least one transmission resource pool among the existing sidelink communication transmission resource pools is configured to be used for a specific UAV service message type, for example, at least one transmission resource pool for a BRID type or at least one transmission resource pool for a DAA type is configured.

However, a case where the existing sidelink communication transmission resource pool is shared and used for UAV service message transmission does not exclude a case where no transmission resource pool for a specific UAV service message type, for example, no transmission resource pool for a BRID type or no transmission resource pool for a DAA type is configured, and in such a case, if it is determined that there is no transmission resource pool configured for a specific UAV service message type (e.g., BRID, DAA, etc.) that the UE desires to transmit, the UE may select the existing sidelink communication transmission resource pool which is not configured for the BRID type and not configured for the DAA type, and may allocate a transmission resource from the selected transmission resource pool.

FIG. 6 illustrates an operation of a UE for selecting a UAV transmission resource pool in a wireless communication system according to an embodiment of the present disclosure.

Referring to FIG. 6, in operation 601, when a UE performs A2X communication by using a PC5 direct communication scheme, the UE may determine whether there is data to be transmitted on a logical channel corresponding to a UAV service message. It is assumed that mapping between a PC5 QoS flow corresponding to a UAV service message to be transmitted by the UE and a sidelink radio bearer and a sidelink logical channel is configured through an NR sidelink communication framework, or mapping between a sidelink radio bearer and a sidelink logical channel is configured for a packet corresponding to a UAV service message to be transmitted by the UE through an LTE sidelink communication/LTE V2X communication framework. In operation 602, if it is determined based on the determination in operation 601 that there is the data to be transmitted for the corresponding logical channel, the UE may determine whether it is necessary to select a transmission resource pool for the data to be transmitted for the corresponding logical channel. If it is determined based on the determination in operation 602 that there is a transmission resource pool already selected for the corresponding logical channel when there is the data to be transmitted for the corresponding logical channel, the UE may allocate a transmission resource from the selected transmission resource pool and transmit the data in operation 601 by using the allocated transmission resource.

In operation 603, if it is determined based on the determination in operation 602 that the UE is required to select a transmission resource pool for the corresponding logical channel when there is the data to be transmitted for the corresponding logical channel, the UE may determine whether there is a transmission resource pool configured separately for UAV service message transmission.

In operation 604, the UE may determine whether there is the transmission resource pool configured separately for UAV service message transmission. If it is determined that there is the transmission resource pool configured separately for UAV service message transmission, the UE may proceed to operation 605 to select the transmission resource pool configured separately for UAV service message transmission and allocate a transmission resource from the selected transmission resource pool. The operation of allocating the transmission resource from the selected transmission resource pool by the UE in operation 605 may include an operation of selecting a transmission resource by the UE based on sensing in mode 2 of an NR sidelink communication framework or an operation of selecting a transmission resource by the UE based on sensing in mode 4 of an LTE V2X communication framework. Alternatively, the operation of selecting the separate transmission resource pool for UAV service message transmission by the UE in operation 605 may be performed by determining, as in the embodiment of FIG. 5, whether the transmission resource pool configured separately for UAV service message may be configured to be used for specific UAV service message types, for example, distinguishably configured for a BRID type and a DAA type.

In operation 604, if it is determined that there is no transmission resource pool configured separately for UAV service message transmission, the UE may proceed to operation 606 to determine whether the existing sidelink communication transmission resource pool is configured to be used for UAV service message transmission, and determine whether the existing sidelink communication transmission resource pool allowed for UAV service message transmission is configured to be used for specific UAV service message types, for example, distinguishably configured for a BRID type and a DAA type. That is, in operation 606, the existing sidelink communication transmission resource pool allowed for UAV service message transmission may be configured to transmit only a BRID type message, may be configured to transmit only a DAA type message, or may be configured to be used for both the BRID type and the DAA type, and the UE may determine whether the existing sidelink communication transmission resource pool allowed for UAV service message transmission is configured to transmit only the BRID type message, configured to transmit only the DAA type message, or configured to be used for both the BRID type and the DAA type. An embodiment of the operation of determining whether the existing sidelink communication transmission resource pool is configured to be used for UAV service message transmission by the UE in operation 606 may include the embodiment of FIG. 3.

In operation 607, the UE may determine whether the logical channel in operation 601 corresponds to a specific UAV service message type, for example, corresponds to BRID and corresponds to DAA.

In operation 608, the UE may determine that the logical channel corresponds to BRID. If it is determined in operation 608 that the logical channel corresponds to BRID, in operation 609, the UE may determine whether the existing sidelink communication transmission resource pool for UAV service message transmission is configured for the BRID type. If it is determined in operation 608 that the logical channel does not correspond to BRID, in operation 611, the UE may determine whether the existing sidelink communication transmission resource pool for UAV service message transmission is configured for the DAA type. When the existing sidelink communication transmission resource pool is configured to be shared and used for a specific UAV service message type, the existing sidelink communication transmission resource pool for UAV service message transmission configured for the BRID type may include a transmission resource pool configured to transmit only the BRID type message or a transmission resource pool configured to be used in both the BRID type and the DAA type.

In operation 609, the UE may determine that the existing sidelink communication transmission resource pool for UAV service message transmission is configured for the BRID type.

In operation 610, if it is determined that the existing sidelink communication transmission resource pool for UAV service message transmission is configured for the BRID type, the UE may select the existing sidelink communication transmission resource pool for UAV service message transmission configured for the BRID type and allocate a transmission resource from the selected pool. Although not illustrated in FIG. 6, if it is determined based on the determination in operation 609 that the existing sidelink communication transmission resource pool for UAV service message transmission is not configured for the BRID type, the UE may select the existing sidelink communication transmission resource pool which is not configured for the BRID type and not configured for the DAA type, and may allocate a transmission resource from the selected transmission resource pool. If it is determined based on the determination in operation 608 that the logical channel of the data to be transmitted does not correspond to BRID, the UE may determine that the logical channel in operation 601 corresponds to DAA. In the embodiment of FIG. 6, it is described under an assumption that a UAV service message corresponds to BRID or corresponds to DAA, but other UAV service message types which do not correspond to BRID and DAA are not excluded. Even for other UAV service message types which do not correspond to BRID and DAA, the UE may operate similarly to the embodiment of FIG. 6.

In operation 611, the UE may determine that the existing sidelink communication transmission resource pool for UAV service message transmission is configured for the DAA type. When the existing sidelink communication transmission resource pool is configured to be shared and used for a specific UAV service message type, the UAV service message transmission resource pool configured for the DAA type may include a transmission resource pool configured to transmit only the DAA type message or a transmission resource pool configured to be used in both the BRID type and the DAA type.

In operation 612, if it is determined in operation 611 that the existing sidelink communication transmission resource pool for UAV service message transmission is configured for the DAA type, the UE may select the existing sidelink communication transmission resource pool for UAV service message transmission configured for the DAA type and allocate a transmission resource from the selected pool. Although not illustrated in FIG. 6, if it is determined based on the determination of the UE in operation 611 that the existing sidelink communication transmission resource pool for UAV service message transmission is not configured for the DAA type, the UE may select the existing sidelink communication transmission resource pool which is not configured to be used for a specific UAV service message type, for example, not configured for the BRID type and not configured for the DAA type, and may allocate a transmission resource from the selected transmission resource pool. The operation of allocating the transmission resource from the selected transmission resource pool by the UE in operation 610 or 612 may include an operation of selecting a transmission resource by the UE based on sensing in mode 2 of an NR sidelink communication framework or an operation of selecting a transmission resource by the UE based on sensing in mode 4 of an LTE V2X communication framework.

In the embodiment of FIG. 6, an HARQ feedback may be configured for a logical channel corresponding to a UAV service message. That is, in a case where the UAV service message is transmitted and received through a sidelink unicast connection or a sidelink groupcast connection, an HARQ feedback may be configured for a logical channel for a certain UAV service message and an HARQ feedback may not be configured for a logical channel for a certain UAV service message. When an HARQ feedback is configured for a logical channel for a UAV service message, the UE may select a transmission resource pool in which an HARQ feedback channel (e.g., a physical sidelink feedback channel (PSFCH)) is configured. An embodiment in which an HARQ feedback is configured for a logical channel corresponding to a DAA service message among UAV service message types may be considered. For example, if data to be transmitted by the UE corresponds to the DAA service message, a sidelink unicast connection is established for the DAA service message, and the HARQ feedback is configured for the logical channel corresponding to the DAA service message, in operation 612, the UE may select a transmission resource pool in which an HARQ feedback resource is configured, and allocate a transmission resource from the selected transmission resource pool.

Although not illustrated in FIG. 6, if it is determined based on the determination in operation 609 or 611 that the existing sidelink communication transmission resource pool for UAV service message transmission is not configured to be used for a specific UAV service message type, for example, for the BRID type or the DAA type, and it is determined that an HARQ feedback is configured for a logical channel for a UAV service message corresponding to a specific UAV service message type, for example, for the BRID type or the DAA type, the UE may select the existing sidelink communication transmission resource pool which is not configured for the BRID type and not configured for the DAA type and in which an HARQ feedback channel (e.g., a PSFCH channel) is configured, and allocate a transmission resource from the selected transmission resource pool.

According to an embodiment of the disclosure, a method for allocating a transmission resource by a UE to transmit an SL CSI reporting MAC CE is described. This may be applicable to a case where, when a UAV service message among UAV service messages is transmitted and received using a sidelink unicast scheme, an SL CSI reporting MAC CE is required to be transmitted and received for a sidelink unicast connection. In general, for example, a service message corresponding to BRID may be transmitted and received using a sidelink broadcast scheme, and a service message corresponding to DAA may be transmitted and received using a sidelink broadcast, sidelink groupcast, and sidelink unicast scheme depending on a DAA service scenario. The embodiment of the disclosure does not exclude a scenario in which a BRID service message may be transmitted and received using a sidelink unicast scheme. When a UAV service message establishes a sidelink unicast connection between two UEs and is transmitted and received using the corresponding unicast connection, SL CSI measurement and reporting procedures may be performed for the sidelink unicast connection. In this case, one UE may request a counterpart UE to report an SL CSI measurement value, and the counterpart UE may transmit an SL CSI reporting MAC CE to the UE having requested the SL CSI measurement reporting. The UE required to transmit the SL CSI reporting MAC CE may allocate a transmission resource for transmitting the SL CSI reporting MAC CE.

When the UE is required to transmit the SL CSI reporting MAC CE for a unicast connection for UAV service message transmission and reception, the UE may select a transmission resource pool configured to be used for UAV service message transmission, that is, configured to be used in A2X communication using a PC5 direct communication scheme, and allocate a transmission resource from the selected transmission resource pool. According to an embodiment of the disclosure, if there is a separate transmission resource pool configured for UAV service message transmission, the UE may select a transmission resource for transmitting an SL CSI reporting MAC CE from a transmission resource pool configured for UAV service message transmission. If a separate transmission resource pool is not configured for UAV service message transmission, the UE may select a transmission resource for transmitting an SL CSI reporting MAC CE from the existing sidelink communication transmission resource pool configured to enable UAV service message transmission.

According to an embodiment of the disclosure, when a separate transmission resource pool is configured for UAV service message transmission and is configured to be used for a specific UAV service message type, for example, distinguishably configured for a BRID type or a DAA type, the UE may select a transmission resource for transmitting an SL CSI reporting MAC CE from a transmission resource pool configured for the DAA type. Here, it is assumed that a sidelink unicast connection is not established for a BRID service message. If the SL CSI reporting MAC CE is for a sidelink unicast connection corresponding to BRID transmission, the UE may select a transmission resource for transmitting an SL CSI reporting MAC CE from a transmission resource pool configured for the BRID type. If there is a transmission resource pool configured to be used for a specific UAV service message type, for example, to be used in both the BRID type and the DAA type, the transmission resource pool may be used for the BRID type as well as for the DAA type. When a separate transmission resource pool used for a UAV service message for transmitting an SL CSI reporting MAC CE is not configured for the DAA type or is not configured for the BRID type, the UE may select a transmission resource for transmitting an SL CSI reporting MAC CE from the existing sidelink communication transmission resource pool configured to enable UAV service message transmission.

In a case where an SL CSI reporting MAC CE transmission resource is selected from the existing sidelink communication transmission resource pool, if the existing sidelink communication transmission resource pool is configured to be used for a specific UAV service message type, for example, distinguishably configured for the BRID type and the DAA type, the UE may select a transmission resource pool corresponding to a service type (e.g., BRID or DAA) corresponding to a unicast connection corresponding to an SL CSI reporting MAC CE, and allocate an SL CSI reporting MAC CE transmission resource from the corresponding transmission resource pool.

According to an embodiment of the disclosure, an operation method of a UE for configuring a transport block (TB) to be transmitted in a transmission resource allocated for UAV service message transmission is as follows. In a case where, when a transmission resource capable of transmitting a UAV service message is allocated, the UE configures a transport block (TB) which is to use the allocated transmission resource, for a case where the allocated transmission resource is allocated from a transmission resource pool configured separately for UAV service message transmission or a case where the allocated transmission resource is allocated from a transmission resource pool configured for UAV service message transmission among the existing sidelink communication transmission resource pools, when the allocated transmission resource is configured to be used for a specific UAV service message type, for example, configured separately for a transmission resource pool for a BRID type and a transmission resource pool for a DAA type, the UE may configure a TB including logical channel(s) corresponding to BRID so that the TB may be transmitted in a transmission resource allocated from the transmission resource pool for the BRID type, or may configure a TB including logical channel(s) corresponding to DAA so that the TB may be transmitted in a transmission resource allocated from the transmission resource pool for the DAA type. In a case of using a transmission resource allocated from a transmission resource pool configured to be used for a specific UAV service message type, for example, configured to be able to transmit both a BRID type message and a DAA type message, the UE may configure a TB so that logical channel(s) corresponding to BRID and logical channel(s) corresponding to DAA may be included in the same TB.

However, even in a case of using a transmission resource allocated from a transmission resource pool configured to be used for a specific UAV service message type, for example, configured to be able to transmit both a BRID type message and a DAA type message, if a destination layer-2 ID corresponding to BRID and a destination layer-2 ID corresponding to DAA are configured separately, the UE may configure a TB so that logical channel(s) corresponding to BRID and logical channel(s) corresponding to DAA are not included in the same TB. In this case, one TB may be configured to include only an MAC PDU belonging to the same destination layer-2 ID, or one TB may be configured to include only an MAC PDU belonging to the same destination layer-2 ID and source layer-2 ID. Alternatively, even in a case of using a transmission resource allocated from a transmission resource pool configured to be used for a specific UAV service message type, for example, configured to be able to transmit both a BRID type message and a DAA type message, if a destination layer-2 ID pool corresponding to BRID and a destination layer-2 ID pool corresponding to DAA are configured separately, the UE may configure a TB so that logical channel(s) corresponding to BRID and logical channel(s) corresponding to DAA are not included in the same TB. One TB may be configured to include only an MAC PDU belonging to the same destination layer-2 ID pool, or one TB may be configured to include only an MAC PDU belonging to the same destination layer-2 ID pool and source layer-2 ID pool.

For a case of a transmission resource pool configured separately for UAV service message transmission or a case of a transmission resource pool configured for UAV service message transmission among the existing sidelink communication transmission resource pools, if a destination layer-2 ID corresponding to BRID and a destination layer-2 ID corresponding to DAA may be configured to be the same in a case where a transmission resource pool is configured to be used for a specific UAV service message type, for example, may be used for both a BRID type and a DAA type, the UE may configure a TB so that logical channel(s) corresponding to BRID and logical channel(s) corresponding to DAA may be transmitted in the same TB, by using a transmission resource allocated to transmit a packet of a logical channel corresponding to BRID or a packet of a logical channel corresponding to DAA.

For a case of a transmission resource pool configured separately for UAV service message transmission or a case of a transmission resource pool configured for UAV service message transmission among the existing sidelink communication transmission resource pools, if a destination layer-2 ID corresponding to BRID and a destination layer-2 ID corresponding to DAA may be configured to be the same in a case where a transmission resource pool is configured to be used for a specific UAV service message type, for example, configured to be used only for a BRID type or only for a DAA type, the UE may configure a TB to include only logical channel(s) corresponding to BRID in a transmission resource allocated to transmit a packet of a logical channel corresponding to BRID, and may configure a TB to include only logical channel(s) corresponding to DAA in a transmission resource allocated to transmit a packet of a logical channel corresponding to DAA.

According to the embodiments of FIGS. 4, 5, and 6, when the UE selects a transmission resource pool for transmitting a UAV service message, more than one candidate transmission resource pool may be selected for the purpose of a UAV service message to be transmitted. According to an embodiment of the disclosure, when there is more than one candidate transmission resource pool for a UAV service message that the UE desires to transmit, various embodiments of a UE operation for selecting one pool for transmitting a UAV service message may include the following.

### Embodiment 1

When there is more than one selected candidate transmission resource pool, the UE may randomly select one transmission resource pool and allocate a transmission resource from the corresponding transmission resource pool.

### Embodiment 2

When there is more than one selected candidate transmission resource pool, the UE may select a transmission resource pool which is mapped to a logical channel priority of a packet to be transmitted or a priority (PPPP) of the packet, and allocate a transmission resource from the corresponding transmission resource pool. The embodiment 2 is based on an assumption that a logical channel priority or a packet priority is mapped to a transmission resource pool configured to enable UAV service message transmission.

### Embodiment 3

When there is more than one selected candidate transmission resource pool, the UE may determine a channel busy ratio (CBR) of a transmission resource pool, select one transmission resource pool having the lowest CBR, and allocate a transmission resource from the corresponding transmission resource pool. Alternatively, when there is more than one selected candidate transmission resource pool, the UE may determine a CBR of a transmission resource pool, select one transmission resource pool having a CBR lower than a threshold, and allocate a transmission resource from the corresponding transmission resource pool.

### Embodiment 4

When there is more than one selected candidate transmission resource pool, the UE may select one transmission resource pool, based on a CBR corresponding to a transmission resource pool and a logical channel priority or a packet priority, and allocate a transmission resource from the corresponding transmission resource pool. The logical channel priority or packet priority may be a priority of a logical channel corresponding to a packet that the UE desires to transmit or a priority of the corresponding packet.

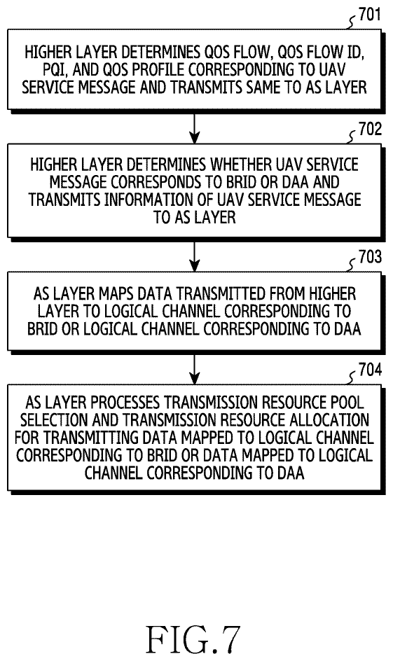

According to an embodiment of the disclosure, in order for the UE to select a transmission resource pool for transmitting a UAV service message, the UE may be able to determine whether a packet to be transmitted is a UAV service message, and when a transmission resource pool is configured to be used for a specific UAV service message type, for example, distinguishing between a BRID type and a DAA type, the UE may be able to determine whether a packet to be transmitted corresponds to a specific UAV service message type, for example, corresponds to BRID or DAA. Information on a packet to be transmitted by the UE may be transmitted from a UE higher layer (e.g., ProSe layer, A2X ProSe layer, etc.) to a UE lower layer (AS layer). Referring to FIG. 7, an embodiment of UE higher layer and UE lower layer operations for processing information required for selecting a UAV transmission resource pool will be described.

FIG. 7 illustrates an operation of a UE internal layer for processing a UAV transmission resource pool in a wireless communication system according to an embodiment of the present disclosure.

Referring to FIG. 7, in operation 701, when a UE is authenticated to perform A2X communication through direct communication through a PC5 interface, a UE higher layer (e.g., ProSe layer, A2X ProSe layer, etc.) may configure a PC5 QOS flow to enable transmission and reception of a UAV service message, such as a BRID type message and a DAA type message, via A2X communication. One or more PC5 QoS flows may be configured depending on the traffic characteristics of the UAV service message. The PC5 QOS flows may be distinguished by information on a QoS flow identifier and a QoS profile. When the UAV service message is transmitted and received through a unicast connection between two UEs, information such as a PC5 QoS flow, a PC5 QOS flow identifier, and a PC5 QoS profile may be exchanged between the two UEs via PC5-S signaling. In a case of being based on an LTE sidelink communication/LTE V2X communication framework, ProSe per packet priority (PPPP) and ProSe per packet reliability (PPPR) may be configured depending on the traffic characteristics of the UAV service message.

The UE higher layer may transmit the configured information such as a PC5 QoS flow, a PC5 QOS flow identifier, a PC5 QoS profile, PPPP, and PPPR to an AS layer corresponding to a UE lower layer. When a UAV service message by which A2X communication is to be performed occurs, the information in operation 701 may be transmitted together with the corresponding service message, or the information may be transmitted when a connection (unicast, groupcast, or broadcast) for performing A2X communication and a PC5 QOS flow of the connection are established. The PC5 QOS flow may be configured distinguishably according to specific UAV service message types, for example, with distinguishing between a BRID type and a DAA type. The UE higher layer may perform processing to distinguish one or more UAV service messages based on specific UAV service message types, for example, the BRID type and the DAA type.

In operation 702, when a UAV service message to be transmitted occurs, the UE higher layer may transmit, to a UE AS layer, together with a packet corresponding to the UAV service message, indication information indicating a UAV service message type of the corresponding packet, for example, the BRID type or the DAA type. The indication information indicating the UAV service message type of the packet, for example, the BRID type or the DAA type, may be explicitly included in the corresponding packet and transmitted as a UAV service message type indicator, for example, a BRID/DAA indicator. UAV service message type information of a UAV service message packet, for example, indication information indicating the BRID type or the DAA type may use a destination layer-2 ID identifier corresponding to the packet, and in this case, a destination layer-2 ID pool may be configured separately for each UAV service message type (e.g., the BRID type, the DAA type, etc.).

In a case of transmitting and receiving a UAV service message through a sidelink unicast connection, a source layer-2 ID pool and a destination layer-2 ID pool may be configured separately for each UAV service message type (e.g., the BRID type, the DAA type, etc.), and indication information indicating a UAV service message type of a UAV service message packet, for example, the BRID type or the DAA type may use a source layer-2 ID identifier and a destination layer-2 ID identifier corresponding to the packet. The indication information indicating the UAV service message type of the packet, for example, the BRID type or the DAA type may use a PC5 QOS flow, and in this case, the PC5 QOS flow may be configured separately according to a UAV service message type (e.g., the BRID type, the DAA type, etc.). The UE higher layer may transmit information on a priority (PPPP) of a packet or a priority of a PC5 QoS flow to which the packet belongs to the UE AS layer. The information on the priority of the packet or the priority of the PC5 QoS flow to which the packet belongs may be used in a case where a transmission resource pool is required to be selected based on a priority during a procedure of selecting a transmission resource pool at the UE AS layer. The UE AS layer may perform an operation of allocating a transmission resource for transmitting a UAV service message packet received from the higher layer.

In operation 703, the UE AS layer may perform an operation of mapping a UAV service message packet received from the higher layer to a logical channel based on information on the packet. Depending on a UAV service message type, the UE AS layer may select a logical channel to which the packet may be mapped. For example, when the UAV service message packet corresponds to BRID, the UE AS layer may select a logical channel to which the packet corresponding to BRID may be mapped. When the UAV service message packet corresponds to DAA, the UE AS layer may select a logical channel to which the packet corresponding to DAA may be mapped. When a transmission resource pool for A2X communication is not distinguished for a specific UAV service message type, for example, the BRID type and the DAA type, a packet (or PC5 QoS flow) corresponding to BRID and a packet (or PC5 QoS flow) corresponding to DAA may also be mapped to the same logical channel.

In a case where the transmission resource pool is configured to be used for a specific UAV service message type, for example, distinguishably configured for the BRID type and the DAA type when A2X communication is performed using an LTE sidelink communication/LTE V2X communication framework, the UE may distinguishably configure a logical channel for the BRID type and a logical channel for the DAA type. The UE may configure a priority for the logical channel for the BRID type and configure a priority for the logical channel for the DAA type. In a case where the transmission resource pool is configured to be used for a specific UAV service message type, for example, distinguishably configured for the BRID type and the DAA type when A2X communication is performed using an NR sidelink communication framework, the UE may distinguishably configure a logical channel for the BRID type and a logical channel for the DAA type. The UE may perform PC5 QOS flow, sidelink data radio bearer, and sidelink logical channel mapping so that a radio bearer for the BRID type and a radio bearer for the DAA type may be separated.

When the base station performs PC5 QOS flow and sidelink data radio bearer mapping, the UE may report information on a UAV service message (BRID and DAA indication information) to the base station through a sidelink UE information message, as in the embodiment of FIG. 8, so that the radio bearer for the BRID type and the radio bearer for the DAA type may be separated. The UE may obtain bearer configuration information corresponding to the logical channel for the BRID type (e.g., priority, PBR, bucket size duration, HARQ feedback configuration, etc. configured in logical channel config IE) through a method of an RRC dedicated message, SIB message, or preconfiguration. The UE may obtain bearer configuration information corresponding to the logical channel for the DAA type (e.g., priority, PBR, packet size duration, HARQ feedback configuration, etc. configured in logical channel config IE) through a method of an RRC dedicated message, SIB message, or preconfiguration.

In operation 704, the UE AS layer may perform an operation of selecting a transmission resource pool for transmitting data mapped to a logical channel corresponding to BRID or data mapped to a logical channel corresponding to DAA. When A2X communication is performed using an LTE sidelink communication/LTE V2X communication framework, if a UAV service message packet received from the higher layer corresponds to BRID or DAA, the UE AS layer (RRC layer) may select a transmission resource pool for transmitting the UAV service message packet and transmit the transmission resource pool to the UE AS layer (MAC layer). When A2X communication is performed using an NR sidelink communication framework, if a UAV service message packet received from the higher layer corresponds to a specific UAV service message type, for example, BRID or DAA, the UE AS layer (MAC layer) may select a transmission resource pool for transmitting the UAV service message packet. The UE AS layer (MAC layer) may allocate a resource for transmitting the UAV service message packet from the selected transmission resource pool.

FIG. 8 illustrates signaling between a UE and a base station for processing a UAV transmission resource pool in a wireless communication system according to an embodiment of the present disclosure.

Referring to FIG. 8, in operation 801, a UE 800 may configure a sidelink UE information message to include at least one or a combination of transmission resource request information of a UAV service message to be reported to a base station 820, and request information for requesting a sidelink radio bearer configuration which may be used to transmit a UAV service message. The sidelink UE information message transmitted by the UE 800 to the base station 820 may be transmitted for the purpose of requesting, from the base station 820, information on a transmission resource and a transmission resource pool required when the UE transmits a UAV service message, and the base station 820 may configure a base station scheduling mode (mode 1 in NR and mode 3 in LTE) or a UE scheduling mode (mode 2 in NR and mode 4 in LTE), and provide transmission resource pool information and/or information on a transmission resource, suitable for each configuration to the UE 800. When the UE 800 configures the sidelink UE information message to be transmitted to the base station 820 in operation 801, the UE 800 may include information on a service message of interest, for example, information indicating a UAV service message, and information indicating a UAV service message type, for example, information indicating that a UAV service message corresponds to BRID, information indicating that a UAV service message corresponds to DAA, etc.

When the sidelink UE information message is transmitted to request transmission resource pool and/or transmission resource allocation required for UAV service message transmission, in a case where a destination layer-2 ID pool is separately configured to be used for a UAV service message, the UE may include a destination layer-2 ID corresponding to a UAV service message in the sidelink UE information message. In a case where information indicating that a UAV service message corresponds to a service message type of a UAV service message, for example, BRID and information indicating that a UAV service message corresponds to DAA are distinguished and included in the sidelink UE information message, if a destination layer-2 ID pool is configured to be used for a specific UAV service message type, for example, a destination layer-2 ID pool for a BRID type and a destination layer-2 ID pool for a DAA type are distinguished, the UE may include a destination layer-2 ID for the BRID type in the sidelink UE information message to indicate that the UAV service message corresponds to BRID, and may include a destination layer-2 ID for the DAA type in the sidelink UE information message to indicate that the UAV service message corresponds to DAA.

When the UE transmits the sidelink UE information message to request transmission resource pool and/or transmission resource allocation required for UAV service message transmission, the UE may include indication information on a UAV service message in the sidelink UE information message to indicate that a transmission resource is requested for the UAV service message. In a case where it is necessary to indicate a service message type of a UAV service message, for example, the BRID type or the DAA type, the UE may include indication information for BRID and indication information for DAA in the sidelink UE information message. An embodiment of information which may be included in the sidelink UE information message and indicates a service message type of a UAV service message, for example, whether a UAV service message corresponds to BRID or DAA may include information in [Table 15].

```
TABLE 15
      (Embodiment 1: transmit indication information capable of distinguishing a UAV service
message type via uav-CommTxType, for example, a BRID indicator, a DAA indicator, or an
indicator indicating that both BRID and DAA are available)
      SidelinkUEInformationforUAV-IEs ::= SEQUENCE {
        uav-CommRxInterestedFreqList SL-UAV-CommFreqList,
        uav-Comm TxType ENUMERATED {brid,
daa, both},
        uav-Comm TxResourceReq SL-UAV-CommTxFreqList,
        ...
      }
      (Embodiment 2: transmit indication information capable of distinguishing a UAV service
message type via uav-CommTxResourceReq, for example, DST L2 ID corresponding to BRID
and DST L2 ID corresponding to DAA)
      SL-UAV-CommTxFreqList ::= SEQUENCE (SIZE (1..maxFreqUAV)) OF SL-UAV-
CommTxResourceReq
      SL-UAV-CommTxResourceReq ::= SEQUENCE
        carrierFreqCommTx INTEGER (1..
maxFreqV2XUAV),
        uav-DestinationInfoList UAV-DestinationInfoList, (a destination
identity corresponding to BRID and a destination identity corresponding to DAA may be
reported together)
        uav-DestinationInfoList-BRID UAV-DestinationInfoList, (a destination identity
corresponding to BRID may be reported)
        uav-DestinationInfoList-DAA UAV-DestinationInfoList, (a destination identity
corresponding to DAA may be reported)
        ...
        }
        UAV-DestinationInfoList ::= SEQUENCE (SIZE (1..maxUAV-Dest)) OF UAV-
DestinationIdentity
```

In operation 802, the UE 800 may transmit the sidelink UE information message to the base station 820. When the base station 820 receives the sidelink UE information message in operation 802, the base station 820 may determine that UAV service message transmission is requested, may determine that transmission of a BRID type message is requested or transmission of a DAA type message is requested, through UAV service message type information, for example, BRID indication information and DAA indication information, and may determine a scheduling mode (UE scheduling mode or base station scheduling mode) for UAV service message transmission.

In operation 803, when a UE scheduling mode is configured, the base station 820 may configure transmission resource pool information to be used for UAV service message transmission by the UE 800 in the UE scheduling mode. When a transmission resource pool is configured to be used for a specific UAV service message type, for example, when transmission resource pools for the BRID type and the DAA type are configured respectively, transmission resource pool information may be configured to be used for a specific UAV service message type, for example, transmission resource pool information for the BRID type and the DAA type may be configured.

In operation 804, when a base station scheduling mode is configured, the base station 820 may configure transmission resource pool information to be used for UAV service message transmission by the UE 800 in the base station scheduling mode, and configure configuration information required to allocate a transmission resource to the UE 800. When a transmission resource pool is configured to be used for a specific UAV service message type, for example, when transmission resource pools for the BRID type and the DAA type are configured respectively, transmission resource pool information and transmission resource allocation may be configured to be used for a specific UAV service message type, for example, transmission resource pool information and transmission resource allocation information for the BRID type and the DAA type may be configured. The base station 820 may distinguish whether it is a UAV service message or may distinguish a UAV service message type, for example, the BRID type or the DAA type, based on a destination layer-2 ID reported in the sidelink UE information message, as in the embodiment of [Table 15]. The base station 820 may distinguish whether it is a UAV service message or may distinguish the BRID type or the DAA type, based on indication information for a UAV service message reported in the sidelink UE information message or indication information on a UAV service message type, for example, indication information on BRID or indication information on DAA, as in the embodiment of [Table 15].

In operation 805, when the UE 800 is required to configure sidelink radio bearer information applicable at the time of transmitting a UAV service message, the base station 820 may configure sidelink radio bearer information, based on QoS profile information of the UAV service message. The base station 820 may configure a sidelink radio bearer mapped to a sidelink QoS flow in consideration of a UAV service message type based on information as in the embodiment of [Table 15] reported by the UE 800 in the sidelink UE Information message. For example, the base station 820 may allocate a sidelink QoS flow corresponding to BRID and a sidelink QoS flow corresponding to DAA to separate sidelink radio bearers, respectively. Through this, a sidelink logical channel mapped to the sidelink QoS flow may be established in consideration of a UAV service message type. For example, a sidelink QoS flow for the BRID type and a sidelink QoS flow for the DAA type may be allocated to separate sidelink logical channels.

As such, when a QoS flow for the BRID type and a QoS flow for the DAA type are allocated to separate sidelink logical channels, and thus a transmission resource is configured to be used for a specific UAV service message type, for example, a transmission resource pool for the BRID type and a transmission resource pool for the DAA type are operated separately, an operation of allocating a transmission resource from the transmission resource pool for the BRID type to transmit data corresponding to a BRID logical channel and allocating a transmission resource from the transmission resource pool for the DAA type to transmit data corresponding to a DAA logical channel may be supported. When a transmission resource pool supports both the BRID type and the DAA type, the transmission resource pool may be processed as the transmission resource pool for the BRID type or the transmission resource pool for the DAA type. In FIG. 8, operations 803, 804, and 805 do not need to occur sequentially, but are shown sequentially for ease of description.

In operation 806, the base station 820 may configure an RRC Reconfiguration message including at least one or a combination of transmission resource pool configuration information, transmission resource allocation information, and sidelink radio bearer configuration information configured in operations 803, 804, and 805, and transmit the message to the UE 800.

In operation 807, the UE 800 may obtain at least one or a combination of UAV service message transmission resource pool information, UAV service message transmission resource allocation information, and sidelink radio bearer configuration information from the RRC reconfiguration message transmitted by the base station 820, and use the information to transmit the UAV service message.

While describing operations of a UE and a base station for selecting a transmission resource pool for transmitting a UAV service message and allocating a transmission resource according to various embodiments, a case where at the time of selecting a transmission resource pool for transmitting a UAV service message, the UAV service message corresponds to a specific UAV service message type, for example, corresponds to BRID or DAA has been described as an example. However, the UE may perform an operation of selecting a transmission resource pool and allocating a transmission resource for other UAV service message types in which the UAV service message does not correspond to BRID and DAA. If it is determined that the UAV service message does not correspond to BRID and DAA, and if it is determined that a transmission resource pool is configured separately for UAV service message transmission and the transmission resource pool configured separately for UAV service message transmission is not configured to be used for specific UAV service message types, for example, is not distinguishably configured for a BRID type and a DAA type, the UE may select a transmission resource pool configured to be used for a UAV service message type, for example, configured separately for UAV service message transmission to transmit a UAV service message which does not correspond to BRID and DAA, and may allocate a transmission resource from the selected transmission resource pool.

Alternatively, if it is determined that the type of a UAV service message to be transmitted does not correspond to specific UAV service message types, for example, BRID and DAA, if it is determined that a transmission resource pool is configured separately for UAV service message transmission and a transmission resource pool is configured to be used for specific UAV service message types, for example, distinguishably configured for a BRID type and a DAA type, and if it is determined that there is the existing transmission resource pool configured for the sidelink communication purpose that allows transmission of a UAV service message, the UE may select a transmission resource pool from the corresponding transmission resource pool configured for the sidelink communication purpose and allocate a transmission resource from the selected transmission resource pool. In this case, if it is determined that the existing sidelink communication transmission resource pool is configured to be used for a specific UAV service message type, for example, distinguishably configured for a BRID type and a DAA type, the UE may select the existing sidelink communication transmission resource pool allowed for a UAV service message, which is not configured to be used for a specific UAV service message type, for example, not configured for a BRID type and a DAA type, and allocate a transmission resource from the selected pool.

Alternatively, if it is determined that a transmission resource pool is not separately configured to be used for a UAV service message and the existing transmission resource pool configured for the sidelink communication purpose is allowed for UAV service message transmission, the UE may select a transmission resource pool from the corresponding transmission resource pool configured for the sidelink communication purpose and allocate a transmission resource from the selected transmission resource pool. In this case, if it is determined that the existing transmission resource pool configured for the sidelink communication purpose is configured to be used for a specific UAV service message type, for example, distinguishably configured for a BRID type and a DAA type, the UE may select the existing sidelink communication transmission resource pool allowed for a UAV service message, which is not configured to be used for a specific UAV service message type, for example, not configured for a BRID type and a DAA type, and allocate a transmission resource from the selected pool.

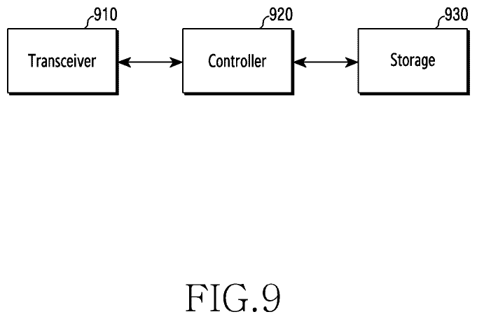

FIG. 9 illustrates a structure of a UE according to an embodiment of the present disclosure.

Referring to FIG. 9, the UE may include a transceiver 910, a controller 920, and a storage 930. The transceiver 910, the controller 920, and the storage 930 may be operated according to the above-described communication methods of the UE. However, components of the UE are not limited to the above-described example. For example, the UE may include a larger or smaller number of components than the above-described components. For example, the UE may include the transceiver 910 and the controller 920. Furthermore, the transceiver 910, the controller 920, and the storage 930 may be implemented in the form of a single chip.

The transceiver 910 refers to a UE receiver and a UE transmitter as a whole, and may transmit/receive signals with a base station and any other UE or network entity. The signals transmitted/received with the base station may include control information and data. The transceiver 910 may receive, for example, system information, synchronization signals, or reference signals from the base station. To this end, the transceiver 910 may include an RF transmitter configured to up-convert and amplify the frequency of transmitted signals, an RF receiver configured to low-noise-amplify received signals and down-convert the frequency thereof, and the like. However, this is only an embodiment of the transceiver 910, and the components of the transceiver 910 are not limited to the RF transmitter and the RF receiver. Also, the transceiver 910 may include wired/wireless transceivers, and may include various components for transmitting/receiving signals. In addition, the transceiver 910 may receive signals through a radio channel, output the same to the controller 920, and transmit signals output from the controller 920 through the radio channel. Furthermore, the transceiver 910 may receive communication signals, output same to a processor, and transmit signals output from the processor to a network entity through a wired/wireless network.

The storage (e.g., memory) 930 may store programs and data necessary for operations of the UE. In addition, the storage 930 may store control information or data included in signals acquired by the UE. The 930 may include storage media such as a ROM, a RAM, a hard disk, a CD-ROM, and a DVD, or a combination of storage media.

As used herein, the controller 920 may be defined as a circuit, an application specific integrated circuit, or at least one processor. The processor may include a communication processor (CP) which performs control for communication and an application processor (AP) which controls upper layers such as application programs. The controller 920 may control the overall operation of the UE according to the embodiments provided in the disclosure. For example, the controller 920 may control signal flows between the respective blocks to perform operations according to the above-described flowcharts.

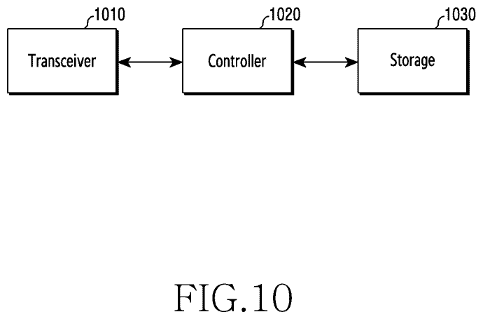

FIG. 10 illustrates a structure of a base station according to an embodiment of the present disclosure.

Referring to FIG. 10, the base station according to an embodiment of the disclosure may include a transceiver 1010, a controller 1020, and a storage 1030. The transceiver 1010, the controller 1020, and the storage 1030 may be operated according to the above-described communication methods of the base station. However, components of the base station are not limited to the above-described example. For example, the base station may include a larger or smaller number of components than the above-described components. For example, the base station may include the transceiver 1010 and the controller 1020, and the transceiver 1010 may additionally include a backhaul communication unit for communication with any other network entity. Furthermore, the transceiver 1010, the controller 1020, and the storage 1030 may be implemented in the form of a single chip.

The transceiver 1010 refers to a base station receiver and a base station transmitter as a whole, and may transmit/receive signals with UEs and any other base stations or network entity. The signals transmitted/received with the UE via wireless communication may include control information and data. The transceiver 1010 may transmit, for example, system information, synchronization signals, or reference signals to the UE. To this end, the transceiver 1010 may include an RF transmitter configured to up-convert and amplify the frequency of transmitted signals, an RF receiver configured to low-noise-amplify received signals and down-convert the frequency thereof, and the like. However, this is only an embodiment of the transceiver 1010, and the components of the transceiver 1010 are not limited to the RF transmitter and the RF receiver. Also, the transceiver 1010 may include wired/wireless transceivers, and may include various components for transmitting/receiving signals. In addition, the transceiver 1010 may receive signals through a radio channel, output the same to the controller 1020, and transmit signals output from the controller 1020 through the radio channel. Furthermore, the transceiver 1010 may receive communication signals, output same to a processor, and transmit signals output from the processor to any other network entity through a wired/wireless network.

The storage 930 may store basic programs, application programs, and data such as configuration information necessary for operations of the base station. In addition, the storage 1030 may store data such as configuration information regarding a transmission resource pool for A2X communication to be used by a connected UE, configuration information regarding bearers, and system information to be provided to UEs in a serving area. Also, the storage 1030 may provide the stored data at the request of the controller 1020.

As used herein, the controller 1020 may be defined as a circuit, an application specific integrated circuit, or at least one processor. The processor may include a communication processor (CP) which performs control for communication and an application processor (AP) which controls upper layers such as application programs. The controller 1020 may control the overall operation of the base station according to the embodiments provided in the disclosure. For example, the controller 1020 may control signal flows between the respective blocks to perform operations according to the above-described flowcharts.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, first configuration information allocating a sidelink resource pool for aerial to everything (A2X) communication;
identifying whether a logical channel in which a sidelink data is available is for a broadcast remote UE identification (BRID) or a detect and avoid (DAA) for the A2X communication;
in case that the logical channel is for the BRID or the DAA, selecting a resource pool among the sidelink resource pool based on the first configuration information; and
performing the A2X communication based on the selected resource pool.

2. The method of claim 1, further comprising:
in case that the logical channel is for the BRID, identifying that second configuration information indicating a service for the resource pool is the BRID or both of the BRID and the DAA are configured for the first configuration information,
wherein the resource pool is selected based on the second configuration information.

3. The method of claim 1, further comprising:
in case that the logical channel is for the DAA, identifying that third configuration information indicating a service for the resource pool is the DAA or both of the BRID and the DAA are configured for the first configuration information,
wherein the resource pool is selected based on the third configuration information.

4. The method of claim 2, wherein, in case that the second configuration information is not configured for the first configuration information, the resource pool is not selected based on the second configuration information, and
wherein the resource pool is selected except for the resource pool in the first configuration information.

5. The method of claim 3, wherein, in case that the third configuration information is not configured for the first configuration information, the resource pool is not selected based on the third configuration information, and
wherein the resource pool is selected except for the resource pool in the first configuration information.

6. The method of claim 1, wherein the first configuration information is for configuring a dedicated resource pool for the UE or for configuring a common resource pool for UEs.

7. The method of claim 1, whether the logical channel is for the BRID or the DAA is identified based on quality of service (QOS) information associated with the BRID or the DAA.

8. The method of claim 1, wherein the sidelink data comprises one more medium access

9. A user equipment (UE) in a wireless communication system, the UE comprising:
a transceiver, and
a controller coupled with the transceiver and configured to:
receive, from a base station, first configuration information allocating a sidelink resource pool for aerial to everything (A2X) communication;
identify whether a logical channel in which a sidelink data is available is for a broadcast remote UE identification (BRID) or a detect and avoid (DAA) for the A2X communication;
in case that the logical channel is for the BRID or the DAA, select a resource pool among the sidelink resource pool based on the first configuration information; and
perform the A2X communication based on the selected resource pool.

10. The UE of claim 9, wherein the controller is configured to:
in case that the logical channel is for the BRID, identify that second configuration information indicating a service for the resource pool is the BRID or both of the BRID and the DAA are configured for the first configuration information,
wherein the resource pool is selected based on the second configuration information.

11. The UE of claim 9, wherein the controller is further configured to:
in case that the logical channel is for the DAA, identify that third configuration information indicating a service for the resource pool is the DAA or both of the BRID and the DAA are configured for the first configuration information,
wherein the resource pool is selected based on the third configuration information.

12. The UE of claim 10, wherein, in case that the second configuration information is not configured for the first configuration information, the resource pool is not selected based on the second configuration information, and
wherein the resource pool is selected except for the resource pool in the first configuration information.

13. The UE of claim 11, wherein, in case that the third configuration information is not configured for the first configuration information, the resource pool is not selected based on the third configuration information, and
wherein the resource pool is selected except for the resource pool in the first configuration information.

14. The UE of claim 9, wherein the first configuration information is for configuring a dedicated resource pool for the UE or for configuring a common resource pool for UEs.

15. The UE of claim 9, whether the logical channel is for the BRID or the DAA is identified based on quality of service (QOS) information associated with the BRID or the DAA.

16. The UE of claim 9, wherein the sidelink data comprises one more medium access
